(19) United States
(12) Patent Application Publication
(10) Pub. No.: US 2010/0000882 A1
(43) Pub. Date: Jan. 7, 2010

(54) Detection of Explosive Materials

(75) Inventors: Joseph Wang, San Diego, CA (US); Avi Cagan, Scottsdale, AZ (US)

Correspondence Address: FISH & RICHARDSON, PC, P.O. BOX 1022, MINNEAPOLIS, MN, 55440-1022, US

(73) Assignee: Arizona Board of Regents for and on Behalf of Arizona State University

(21) Appl. No.: 12/444,113

(22) PCT Filed: Sep. 14, 2007
(86) PCT No.: PCT/US07/78580

§ 371 Date: May 4, 2009

Related U.S. Application Data
(60) Provisional application No. 60/828,180, filed on Oct. 4, 2006.
(60) Provisional application No. 60/887,736, filed on Feb. 1, 2007.

(51) Int. Cl. G01N 27/26; B01L 11/00

(52) U.S. Cl. 205/781; 422/101; 204/406; 205/775; 205/782

(57) ABSTRACT

Among other things, methods and systems are described for detecting chemicals including explosive materials. For example, a system for detecting materials includes a sample gathering unit designed to obtain a portion of a target material to be tested. In addition, the system includes a sample holding unit that has a first end designed to attach to the sample gathering unit and form a housing that retains at least the obtained portion of the target material. Further, a reagent holding unit is included and designed to attach to a second end of the sample holding unit. The reagent holding unit is designed to introduce the reagent into the formed housing to mix with the obtained target material and start a chemical reaction.

### CLAIM OF PRIORITY

This application claims priority under 35 U.S.C. §119(e) to U.S. patent application Ser. No. 60/828,180, filed on Oct. 5, 2006 and U.S. patent application Ser. No. 60/886,736, filed on Feb. 1, 2007, the entire contents of which is incorporated by reference as part of the specification of this application.

### TECHNICAL FIELD

This application relates to electrochemical detection of chemicals including explosive materials.

### BACKGROUND

Explosive detection can be an important component of the war on terrorism. For example, peroxide-based explosive materials, including triacetone triperoxide (TATP) and hexamethylene triperoxide diamine (HMTD), can be easily synthesized from readily available precursor chemicals. The detection of peroxide-based explosives and chemicals can be challenging because such explosives and chemical lack a nitro group, do not fluoresce, exhibit minimal ultraviolet (UV) absorption, and lack thermal stability. Urea nitrate (UN) is another dangerous material that can be difficult to field detect. As a white powder, UN has an inconspicuous appearance with no distinct characteristics and can be difficult to distinguish from many other materials. In addition, UN's thermal instability and lack of chromophoric groups can hinder field detection.

### SUMMARY

Techniques and systems for detecting chemical including explosive materials are disclosed.

In one aspect, a system for detecting a target material a sample gathering unit designed to obtain a portion of the target material to be tested. The detection system also includes a sample holding unit having a first end designed to be attached to the sample gathering unit and form a housing that retains at least the obtained portion of the target material. A reagent holding unit is attached to a second end of the sample holding unit. The reagent holding unit is designed to introduce the reagent into the formed housing to mix with the obtained target material and start a chemical reaction.

Implementations can optionally include one or more of the following features. The detection system can include an electrochemical sensor unit designed to interface with contents of the formed housing. The detection unit can include a reader designed to interface with the conductive sensor unit to detect an electrical signal associated with the contents of the formed housing. The electrochemical sensor unit can include two or more electrodes. For example, the electrochemical sensor can include a working electrode and a reference electrode. Alternatively, the electrochemical sensor can includes the working electrode, reference electrode an the counter electrode. Also, the reader can be designed to interface with the electrochemical sensor unit to detect the electrical signal associated with the contents of the formed housing. Detecting the electrical signal can include applying a potential through the interfaced electrochemical sensor; in response to the applied potential, measuring at least one of an electrical potential between the working electrode and one of the reference electrode and the counter electrde, and an electrical current between the working electrode and one of the reference electrode and counter electrode. Also, the measured at least one of the electrical potential and electrical current are processed to generate an output signal that indicates a presence or absence of a reaction between an explosive material and the reagent.

Implementations can also include one or more of the following features. The target material tested can include an explosive material. The target material can include one of urea nitrate and a peroxide-based explosive material. The reagent can include a mixture of a solvent and an acid. Alternatively, the target material can include urea nitrate (UN), and the reagent used can include a p-nitrotoluene (NT) based mixture. Also, the target material tested can include one of triacetone triperoxide (TATP) and hexamethylene triperoxide diamine (HMTD), and the reagent used can include a hydrochloric acid (HCl) based mixture.

Also, implementations can include one or more of the following features. The detection system can include a display unit for displaying the determined electrical potential and electrical current. The detection system can include a computing system for processing the determined electrical potential and electrical current.

In another aspect, detecting a target material includes obtaining a sample of a target material to be tested, and sealing the obtained sample of the target material in a detection unit. A reagent is introduced into the detection unit to mix with the target material, with the reagent being designed to start a chemical reaction and generate a product when mixed with an explosive material. An electrochemical signal is measured with the measured electrochemical signal being associated with the mixture of reagent and the target material. The measured electrochemical signal is processed to generate an output that indicates a presence or absence of a chemical reaction between the target material land the reagent.

Implementations can optionally include one or more of the following features. Processing the measured electrochemical signal can include obtaining a signal profile associated with the mixture of the reagent and the target material. Processing the measured electrochemical signal can also include comparing the obtained signal profile against a signal profile associated with a reaction between the reagent and an explosive material. Comparing the obtained signal profile with the signal profile associated with a reaction between the reagent and an explosive material can further include identifying a presence of at least one of urea nitrate and a peroxide-based explosive material in the target material. Also, identifying a presence of at least one of urea nitrate and a peroxide-based explosive material in the target material can include identifying a presence of urea nitrate (UN) in the target material; and identifying a presence of a reaction product comprising 2,4-dinitrotoluene (2,4-DNT). Identifying a presence of at least one of urea nitrate and a peroxide-based explosive material in the target material can include identifying a presence of one of triacetone triperoxide (TATP) and hexamethylene triperoxide diamine (HMTD) in the target material; and identifying a presence of a reaction product comprising hydrogen peroxide (H₂O₂).

Testing the target material can also include displaying the obtained signal profile to a user. Also, measuring an electrochemical signal can include obtaining at least one of an electrical potential and an electrical current. Further, the obtained signal profile can be processed to determine a relationship between a concentration of an explosive material and a magnitude of the signal profile. Introducing the reagent into the detection unit can include automatically introducing the reagent into the detection unit when the obtained sample of the target material is sealed in the detection unit.

In another aspect, a system for testing a target material includes a sample gathering unit designed to obtain a portion of the target material to be tested, and a sample holding unit having a first end designed to attach to the sample gathering unit and form a housing that retains at least the obtained portion of the target material. The system includes a reagent holding unit attached to a second end of the sample holding unit. The reagent holding unit is configured to introduce the reagent into the formed housing to mix with the obtained target material and start a chemical reaction. The system also includes an electrochemical sensor unit designed to interface with contents of the formed housing, and a reader designed to interface with the conductive sensor unit to detect an electrical signal associated with the contents of the formed housing. The detection system also includes a processor designed to process the detected electrical signal to generate an output signal indicative of a presence of an explosive material in the target material. Processing the detected electrical signal includes generating a signal (voltammetric) profile that includes a relationship between currents measured and potentials applied; and comparing the generated signal profile against a known signal profile of an explosive material.

Implementation can optionally include one or more of the following features. The detection system can also include a light source designed to irradiate the target material.

In another aspect, a microelectrode sensing device includes a substrate, and an array of microelectrode sensors formed on the substrate. Each microelectrode sensor includes one or more conductive layers, that at least partially conducts electricity, formed above the substrate and patterned to include at least a working electrode, and a reference electrode to measure electrical activities associated with a chemical reaction between a target material and a reagent. The microelectrode can also include a reading unit designed to interface the one or more conductive layers, with the reading unit designed to detect the measured electrical activities.

In another aspect, testing a target material includes obtaining a portion of the target material and irradiating the obtained portion of the target material. The irradiated sample of the target material is sealed in a detection unit. in response to sealing the irradiated sample of the target material in a detection unit, a reagent is automatically introduced into the detection unit to mix with the target material. The reagent is designed to start a chemical reaction and generate a product when mixed with an explosive material. Also, an electrochemical signal associated with the mixture of reagent and the target material is measured; and the measured electrochemical signal is processed to generate an output that indicates a presence or absence of a chemical reaction between the target material land the reagent.

In another aspect, a compute program product, embodied on a tangible computer readable-medium, is operable to cause a data processing apparatus to perform operations including obtain an electrical signal associated with a reaction between a target material and a reagent. The operations performed also includes processing the obtained electrical signal to identify a presence of an explosive material in the target material; and based on the processing, generating an output signal. The generated output signal includes at least one of a visual indication of the presence of an explosive material in the target material; and an audio indication of the presence of an explosive material in the target material.

In another aspect, to enable testing of a target material, a removable sample gathering unit designed to obtain a portion of a target material is provided. Also provided is a sample holding unit designed to form a housing that retains at least the obtained portion of the target material. The removable sample gathering unit includes a receptor for receiving the removable sample unit. Further, a reagent holding unit is provided, with the reagent holding unit designed to retain a reagent, interface with the sample holding unit, and introduce the retained reagent into the formed housing of the sample holding unit when the sample holding unit receives the removable sample gathering unit. Enabling testing of the target material also includes measuring an electrical signal associated with contents of the formed housing of the sample holding unit; and processing the measured electrical signal to detect a presence of an explosive material in the target material.

The subject matter described in this specification potentially can provide one or more of the following advantages. The subject matter as described in this specification can be implemented to provide a field-deployable easy-to-use kit for accurate and rapid electrochemical detection of explosive materials such as urea nitrate and peroxide-based explosives. The subject matter as described in this specification can provide a) systematic optimization of the efficiency of the chemical pretreatment and of the electrochemical detection processes; b) a detection design of a user-friendly, highly reliable hand-held device for field testing of explosive materials based on a simplified (“Add-Detect”) assay; and c) extensive evaluation and critical testing of a sensor under relevant screening scenarios. The subject matter described in this specification can be used to implement a portable device for field detection and identification of explosive materials, and such portable device can be designed to possess a very high Percent-of-Detection (Pd) with a minimal False Alarm Rate (FAR)(with Pd>0.9 and FAR<0.05), a fast (5-10 sec) response, built-in data processing, and a wireless option. Also, the portable device can be designed to provide easy operation and training that requires minimal operator activities. Further, the portable device can be designed to provide low operational, consumables, and maintenance costs.

In addition, the subject matter described in this specification potentially can provide one or more of the following advantages. Effective operation of the electrochemical (e.g., carbon-electrode) sensor in strongly acidic media may eliminate the need for an additional neutralization process required in other assays that use enzymes or acid-induced pigment-based optical measurements. In addition, the electrochemical detection process as described in this specification can be implemented to detect various amounts of explosive materials. For example, significantly larger or smaller amounts of explosive materials can be detected than possible with standard assays, such as the pigment-based assay. Further, the detection process can be carried out much faster than other assays, such as the pigment-based assay.

The subject matter described in this specification can be implemented as electrochemical methods or systems for detecting the presence of explosive materials.

### BRIEF DESCRIPTION OF THE DRAWINGS

FIGS. 1a and 1b are block diagrams illustrating a detection system 100 for efficient electrochemical detection of chemicals.

FIGS. 2a and 2b illustrate obtaining solid samples for a target substance.

FIG. 3 is a process flow diagram illustrating a process 300 for detecting one or more target explosive materials.

FIG. 4 illustrates additional features of a detection system.

FIG. 5 illustrates results of an exemplary electrochemical detection of nitroaromatic compounds.

FIG. 6 displays voltammograms for increasing amounts of UN in 4 mg increments.

FIG. 7 shows a block diagram of a detection system designed to detect peroxide-based explosive.

FIG. 8 illustrates the amperometric response for TATP following an acid conversion and neutralization.

FIG. 9a illustrates acid decomposition of TATP in various HCl concentrations.

FIG. 9b illustrates acid decomposition of TATP using various HCl/TATP volumetric ratios.

FIG. 9c shows decomposition of TATP using various acid treatment times.

FIG. 10 displays amperometric response of the PB-modified glassy-carbon electrode upon adding 40 μL of the acid-treated (and neutralized) TATP samples of increasing concentrations.

FIG. 11 illustrates the effects of pH upon H₂O₂ chronoamperometric response at a Prussian-blue modified GCE and at a bare GCE in the presence of 10 ppm horseradish peroxidase and 50 μM ferrocenemethanol.

FIG. 12 displays current-time chronopotentiometric recordings for a blank (0.5 M HCl containing 0.1 M KCl) and increasing additions of H₂O₂ concentrations at a Prussian-blue modified screen-printed electrode.

FIG. 13 demonstrates detection of trace solid amounts of TATP.

FIG. 14 illustrates schematically an amperometric trace that can be obtained when a peroxide-based explosive is photochemically converted to Hydrogen Peroxide at a PB-modified electrode.

FIG. 15 shows exemplary current-time amperometric recordings obtained at a PB-modified electrode (or transducer), in response to a working potential of 0.0V, upon adding UV-treated acetonitrile (a,A,B); 12 μM HMTD (b,A); and TATP (b,B) solutions.

FIG. 16 displays calibration data obtained based on eight successive 4.6 μM additions of HMTD (A) and TATP (B), as well as for 1.0 μM TATP additions (C), in connection to the 5 min UV-lamp (A, B) and 15 sec laser (C) irradiations.

FIG. 17 [00106] FIG. 17 illustrates a comparison of the amperometric response of TATP with that of a standard hydrogen-peroxide solution.

FIG. 18 displays the amperometric response for 12 μM TATP over a prolonged 2.5-hour continuous operation with 5 min UV irradiation.

FIG. 19a shows a cross sectional view of the microelectrode sensor 1900.

FIG. 19b shows a top-down view of the microelectrode sensor.

Like reference symbols and designations in the various drawings indicate like elements.

### DETAILED DESCRIPTION

Detection System

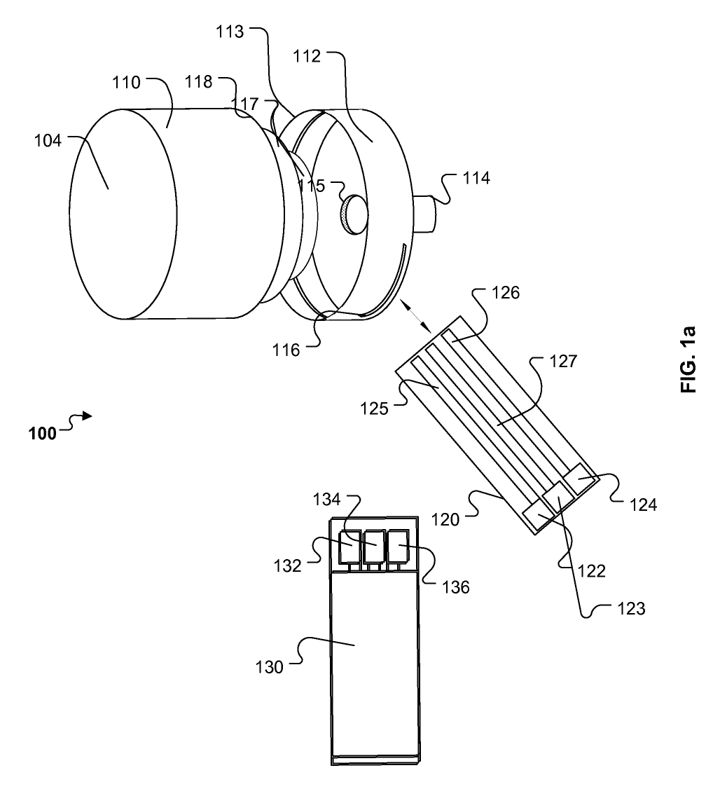

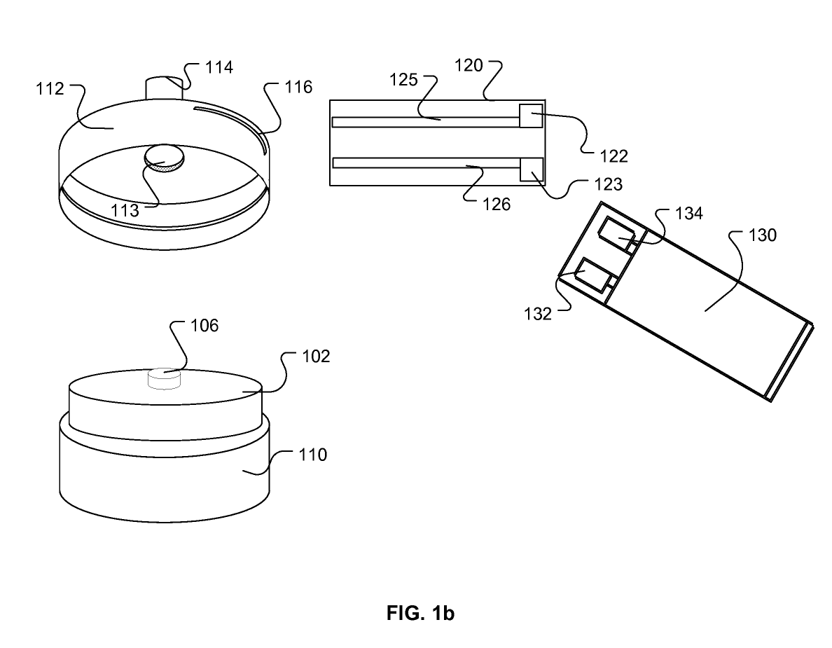

FIGS. 1a and 1b illustrate an exemplary detection system 100 for efficient electrochemical detection of target materials. Among others, the detection system 100 enables efficient field detection of explosive materials such as urea nitrate (UN) and peroxide-based explosive materials in support of various counter-terrorism surveillance activities.

The detection system 100 can be implemented as a rapid, reliable, sensitive, selective and yet simple sensor that can be usable at roadside checkpoints, mass-transit facilities and other public and government facilities to detect explosive materials such as UN. The detection system 100 can be implemented as a portable sensor kit that can be quickly field-deployed when a suspicious material is observed and enable rapid sampling, detection and identification of different amounts of explosive materials in complex matrices and under different environments, with high Percent-of-Detection (Pd) and low False Alarm Rate (FAR).

The detection system 100 implements electrochemical detection of chemicals such as UN. The detection system 100 includes a sample gathering unit (a sampler) 110, a reaction compartment (sample holding unit) 112, a reagent holding unit 114, a sensor unit 120, and a reader 130. The reader 130 is designed to interface with the sensor unit 120 to read data off the sensor unit 120 in response to an electrochemical reaction in the reaction compartment 112.

The sample gathering unit 110 has a surface on one end 104 designed to enable the sample gathering unit 110 to be held in a palm of a hand of a user. The sample gathering unit 110 has a second surface on a second end 102 opposite to the first end 104. The surface on the send end 102 is designed to capture a sample of a target material. The sample gathering unit 110 also includes a reagent releasing unit 106 that interfaces with a surface on one end 113 of the reagent holding unit 114. When the sample gathering unit 110 is inserted into the reaction compartment (sample holding unit) 112, the reagent releasing unit 106 is designed to automatically release the reagent from the reagent holding unit 114. For example, the reagent releasing unit 106 can be designed to puncture a seal on the reagent holding unit 114 to release the reagent. However, other release mechanisms may be implemented. For example, the reagent holding unit 114 can be designed to implement a manual release of the reagent into the sample holding unit 112. For example, the regent holding unit 114 can be implemented as a syringe-like structure to manually release its contents by a push-like action of the user. In such implementations, the same reagent holding unit 114 can be designed to release a desired volume of the reagent, and thus a single reagent holding unit 114 may be reusable. Other manual release mechanisms such as valves can be implemented.

The sample holding unit 112, once combined with the sample gathering unit 110, is designed to be sealed and isolated form its surroundings or to the environment. For example, a rubber seal can be applied to the edge of one end 113 of the sample holding unit 112. Likewise, a rubber seal can be applied to one end 116 of the sample gathering unit 110. When the two ends having the rubber seal meet, a tight seal is formed. Alternatively, the two ends 113 and 116 that attach together can be shaped to form a tight seal. For example, the one end of the sample holding unit 118 can be shaped to include a ridge-like structure 117 that is sized smaller (e.g., smaller circumference, diameter, etc.) to tightly fit within the one end 113 of the sample holding unit 112. This may be similar to a cork fitting into a bottle.

A second end 115 of the sample holding unit 112 is designed to receive and hold the reagent holding unit 114. The similar mechanisms for attaching the sample gathering unit 110 and the sample holding unit 112 may be used to engage 112 to 110. In some implementations, the reagent holding unit 114 can be permanently attached to the sample holding unit 112.

The sample gathering unit 110 and the reaction compartment (sample holding unit) 112 are designed as polymer (e.g., a plastic) containers. However, other materials that can form a chamber for the reaction environment can be used (e.g., glass, metal, etc.)

While the sample gathering unit 110 and the reaction compartment (sample holding unit) 112 are shown as cylindrical structures, other geometries for the structures can be used. For example, a pyramidal structure, a rectangular box structure, a square box structure, a pentagonal box structure, etc. that provides a housing for the reaction to occur can be selected.

The reaction compartment (sample holding unit) 112 includes an interface 116 (e.g., an opening) for receiving and retaining the sensor unit 120. When placed within (e.g., interfacing) with the sample holding unit 112, the sensor unit 120 is designed to interface with the contents of the housing formed when the sample gathering unit 110 is attached to the sample holding unit 112. The sensor unit 120 includes various electrochemical sensors that includes two or more electrodes. For example, the sensor unit can include three electrode leads 125, 126, 127. The three electrode leads 125, 126, and 127 include a reference electrode, a working electrode, and an auxiliary (counter) electrode. In some implementations, the sensor unit can include 2 electrodes only that includes a working electrode and a reference electrode can be implemented. FIG. 1b shows the sensor unit 120 designed with two electrodes 125 and 126 only. The reader 130 in such implementations can be implemented with two contacts 132, 134 only. Both the potential and the current of interest can be measured across the working and reference electrodes. The locations of the reference electrode, working electrode, and auxiliary electrode relative to one another on the sensor device is not critical. When the desired electrochemical reaction occurs, a potential is applied between the working electrode and the reference electrode and a current signal is flowing between the working and counter electrodes. The reference electrode retains a constant electrochemical potential when no current flows through it. The working electrode and the reference electrode can be implemented using bare metal or coated metal. For example, the working and reference electrodes can include silver/silver-chloride electrodes (Ag/AgCl). The auxiliary electrode can be a conductor that completes the circuit and enables current to be applied to the working electrode. The current flowing across the working electrode and the counter electrode can be determined. The auxiliary (counter) electrode can be an inert conductor like platinum or graphite. In some implementations, another piece of the working electrode material can be used to implement the auxiliary electrode. In some implementations more or less than the three described electrode leads 125, 126, 127 can be used.

The electrode leads 125, 126, 127 in the sensor unit 120 can be designed as screen printed electrodes that are modified with an electrocatalyst (such as Prussian Blue or the like). Other electrode designs including a thin film electrode, a transparent optical electrode (such as an Indium-tin-oxide (ITO) electrode), etc. can be implemented. The sensor unit 120 can be designed as an integrated part of the reaction compartment (sample holding unit) 112 or as a separate unit that interfaces with the reaction compartment (sample holding unit) 112. At least one of the electrode leads 125, 126, 127 designed as the working electrode and a reference electrode can be coated with or contain the electrocatalyst.

The sensor unit 120 can be designed to include a glassy carbon working electrode (2 mm diameter; CH Instruments), an Ag/AgCl(3M KCl) reference electrode (CHI 111; CH Instruments), and 0.25 millimeter (mm) diameter platinum wire counter-electrode. Other electrode types that provide the intended behavior of each type of electrode can be used for the working, reference and counter electrodes. For example, the working electrode can be a screen printed electrode, a thin film electrode, a transparent optical electrode (such as an Indium-tin-oxide (ITO) electrode), etc.

A semi-automatic screen printer (e.g., Model TF 100; MPM, Franklin, Mass.) can be used to print the thick film carbon (working and counter) and Ag/AgCl (pseudo reference) electrodes. The carbon ink electrode (G-449(l), Ercon, Wareham, Mass.) and the silver electrode (R-414(DPM-68) 1.25 Ag/AgCl ink, Ercon) can be printed through a patterned stencil on 10 cm×10 cm ceramic plates containing 30 strips (3.3 cm×1.0 cm each), for example. Both printed Ag/AgCl and carbon thick film electrodes are cured at 150 degrees Celsius for 1 hour. An insulating ink (Ercon, E6165-116, Blue Insulator) is subsequently printed on a portion of the plate, leaving sections of the electrode and silver-contact areas on both ends, including a 2×2 mm carbon working electrode. The insulating layer is cured at 100 degrees Celsius for 1 hour.

The sensor unit 120 also includes electrical contacts 122, 123, 124 that enable the reader 130 to interface with the sensor unit 120 to read the electrical potential sensed by the sensor unit 120. To physically interface with the sensor unit 120, the reader 130 also includes electrode contacts 132, 134, 136. In some implementations, contact-less (e.g., wireless) interface can be implemented on the sensor unit 120 and the reader 130.

The reader 130 is a device capable of monitoring an electrical signal, including but not limited to an amperometric signal, a chronoamperometric signal, a voltammetric signal (e.g., cyclic or square-eave voltammetric signal) or potentiometric signal. The later involves passing of a constant current instead of applying a potential. Through the electrode contacts 132, 134, 135, the reader 130 is in connection with the external exposed end (the electrical contacts 122, 123, 124 of the sensor). Such connection enables the reader 130 to apply the appropriate stimulus (e.g., potential) and obtain a reading in response to the applied stimulus. The result of the applied stimulus is presented to a user as a visual (e.g., a signal profile) and/or audio indications that include numerical, graphical or other appropriate display types. The visual and/or audio indications include light emitting diode (LED) indicators, audible output, or the like, and combinations of two or more of these outputs. For example, when an explosive material is detected, a positive reading or indication is provided. When no explosive material is detected, a negative reading or indication is provided. In some implementations, a reading or indication is also provided to represent a “no result” case, for example, where the sensing system 100 failed to operate correctly, or some other factors that prevented a quantitative analysis of the material under test to be completed successfully.

Electrochemical detection of explosive materials can be performed using amperometry, chronoamperometry, cyclic voltammetry, square-wave voltammetry, chronopotentiometry, etc. For example, CHI 1030 Electrochemical Analyzer (CH Instruments, Austin, Tex.) can be used as the reader 130. Other devices that enable amperometry, voltammetry and potentiometry can also be used.

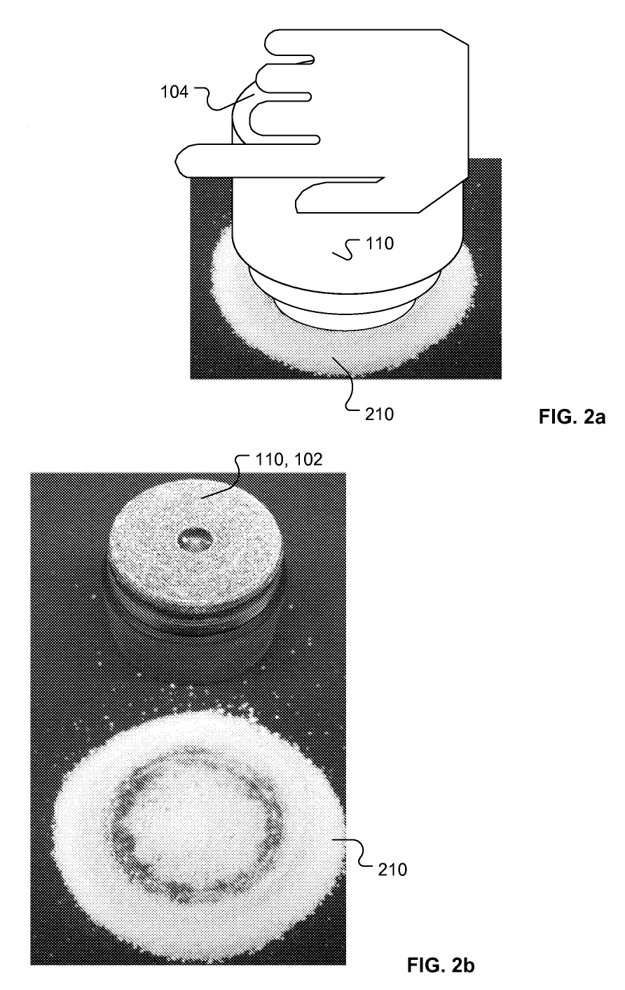

FIGS. 1a and 1b show the sample gathering unit 110 as a cylindrical device with relatively wide (˜4 cm²) surface area 104 designed to be held in a palm of a hand. The shape of the sample gathering unit 110 enable convenient and efficient wiping of target material as shown in FIGS. 2a and 2b. The sample gathering unit 110 is held in the palm of the hand (of a user) by one end 104 and the opposite end 102 of the sample gathering unit 110 (the end not being held in the palm) is swiped against the target material. In some implementations, other shapes (geometric or otherwise) can be implemented to enhance portability, comfort level when held in the palm of the hand, ease of use, etc.

The detection system 100 can be implemented as a compact easy-to-use device that integrates the sample gathering unit 110, the reagent holding unit 114 and the sensor unit 120, along with the hand-held reader 130, for simplified field testing of target chemicals. The detection system can be designed to meet all of the government operational requirements, including (1) high Pd and minimal FAR; (2) high speed; (3) ease of operation and training; (4) minimal operational steps, consumables, and maintenance costs; (5) indoor and outdoor operational capability; (6) low power; (7) transportability; and (8) safety compliance. The detection system 100 is a self-contained compact system that can include a built-in data processing unit (not shown) and a wireless communication unit (not shown). The detection system 100 can be designed to accurately detect (within 5-10 sec) a wide range of chemical (e.g., UN) levels, from 100 μg to 100 mg, with Pd>0.9 and FAR lower than 0.05.

In addition, the detection system 100 is modularized to enable expansion for detecting additional explosive materials and chemicals. For example, various reagent holding unit 114 can be used, one for each target material. By implementing electrochemical detection, the detection system 100 can provide effective field detection of the target materials such as homemade explosives. Some advantages of electrochemical systems include high sensitivity and selectivity, speed, a wide linear range, compatibility with modern microfabrication techniques, minimal space and power requirements, and low-cost instrumentation.

Field Detection

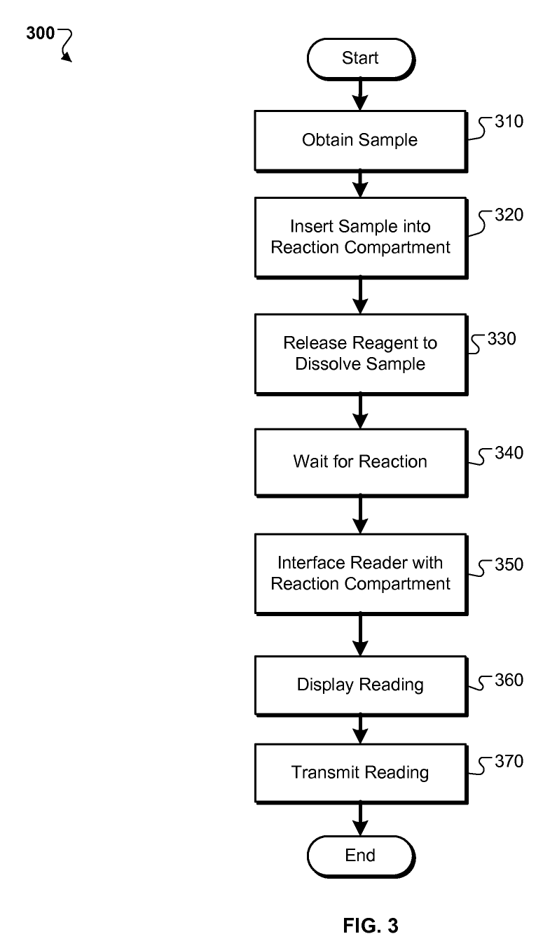

FIG. 3 is a process flow diagram illustrating a process 300 for detecting one or more target explosive materials. A robust detection of emplacement activities can be accomplished by sampling the suspected area independent of human pressurization. A sample of a target material is obtained 310 by swiping the target material with the sample gathering unit 110, for example. The sample gathering unit 110 with the obtained sample is inserted 320 (with the end 102 having the sample) into the reaction compartment (sample holding unit) 112. The insertion process (i.e., joining the sample gathering unit 110 and the reaction compartment (sample holding unit) 112) leads to an automatic release 330 of an reagent solution (from the reagent holding unit) and to an instantaneous dissolution of the sample of the target material. After a short (˜5-10 sec) reaction 340 “under shaking without further operator activity”, leading to the formation of a product, the hand-held reader 130 is interfaced 350 with the reaction compartment (sample holding unit) through the contacts of the sensor unit. Once interfaced, the reader 130 detects the electrical potential sensed by the sensor unit.

The sensor unit 120 can be implemented using a single-use electrode strip (e.g., such as those used for blood glucose diabetic testing) that is mass-produced by the thick-film (screen-printing) microfabrication process. Such sensor strips can be disposable and enable elimination of pre-calibration problems of carry over, cross contamination, or drift. In addition, the combination of the sample gathering unit 110 and the reaction compartment (sample holding unit) 112 provides a closed system that enhances user safety by preventing the user from being exposed to any reagent, solvent, or suspicious chemicals.

The reader 130 can be designed as a small (e.g., pocket-size), light and battery-operated device. When reading or detecting the electrical potential sensed by the sensor unit 120, the reader 130 relies on a potential-scan (e.g., voltammetric) operation and monitors the current output due to the reduction of the product, generated by the reaction, contacting the electrode surface. The results of the potential-scan can be displayed 360 on a display unit (e.g., an analyzer Liquid Crystal screen) and wirelessly transmitted 370 to a processing unit to process and/or store the results.

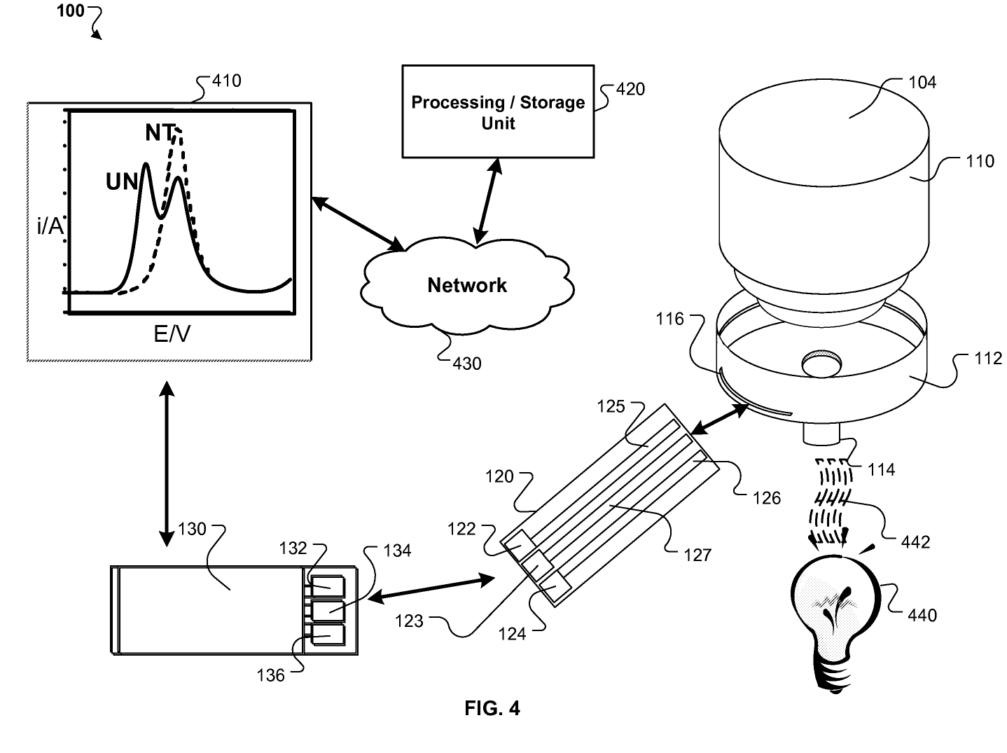

In some implementations, the detection system 100 can include other features. FIG. 4 illustrates additional features of the detection system 100. The detection system 100 can also include a display 410 in communication with the reader 130 for displaying the results of the potential scan. The detection system 100 can also include a processing unit 420 for processing and/or storing the results. The reader 130 can transmit the results over a network 430 (e.g., local area network, internet, etc.) to the processing unit 420. Transmitting the results can be performed over the network automatically without addition signal processing requirements. Such automated transmission capability further minimizes the user involvement, making the detection system available around the clock. The detection system 100 can also include a light source (e.g., UV, laser, etc.) 440 to provide irradiation 442. Irradiation of the target sample is described further below. The light source may be integrated with the sample gathering unit 110, sample holding unit 112, the sensor unit 120, or the reader 130.

Electrochemical Detection of Urea Nitrate (UN)

The detection system 100 as described in this specification implements electrochemical mechanism to detect various explosive materials and chemicals. For example, to detect UN, the detection system 100 can implement an electrochemical test that relies on the regioselective reaction of UN with p-nitrotoluene (NT), in the presence of sulfuric acid, to generate 2,4-dinitrotoluene (2,4-DNT) with a yield of 99% (3). The mechanism of such highly specific UN-induced nitration process involves an initial dehydration to nitro urea which is acting as the nitrating agent (and not as a nitrate ions supplier). NT is an attractive reagent for this reaction due to the presence of ‘deactivating’ nitro group that reduces the likelihood of dinitration. Only very strong nitrating agents, such as urea nitrate, capable of releasing nitronium ion, are able to overcome the lack of electrons on the ring and perform the electrophilic substitution on p-nitrotoluene and nitrate it to generate 2,4-DNT as the product of the reaction. Other strong nitrating agents (4) (e.g., such as nitronium salts, bidentate metal nitrates and dinitro pentoxide) are all synthetic agents and are not likely to be found in common screening environments.

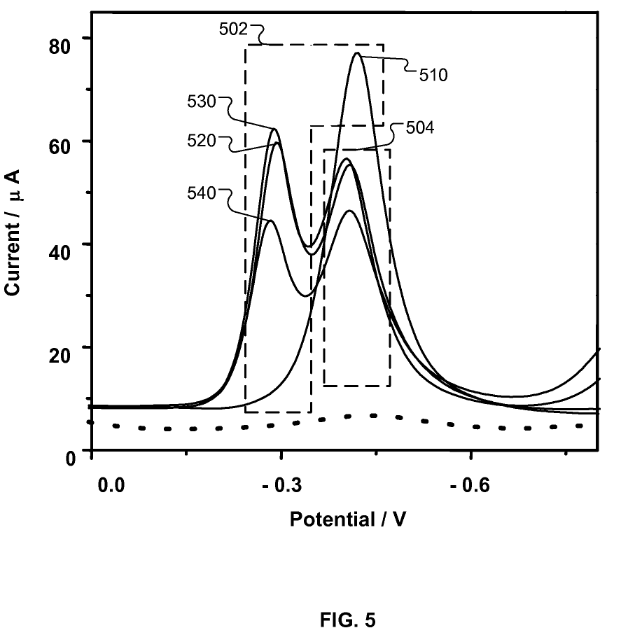

FIG. 5 illustrates results of an exemplary electrochemical (voltammetric) detection of nitroaromatic compounds. Resultant voltammograms (current-potential curves) based on square wave voltammetry (SWV) are shown. The voltammogram for a mono-nitrotoluene (e.g., NT) 510 shows one key reduction peak 502. The voltammogram for a di-nitrotoluene (e.g., 2,4 DNT) 520 displays two well resolved peaks 502, 504 with one 504 of the peaks corresponding to the mono-nitrotoluene peak 502. The voltammetric data in FIG. 5 illustrate that a specific reaction of UN with 4NT results in two reduction peaks 502, 504 for 3 mg UN 530 and 4 mg UN 540. These voltammograms 530 and 540 provide electrochemical signatures that are identical to that of 2,4 DNT (530 vs. 520 and 540 vs. 520). The appearance of the first peak 502 (near voltammetric potential of −0.3 V) can be used to reliably identify the presence and amount of UN.

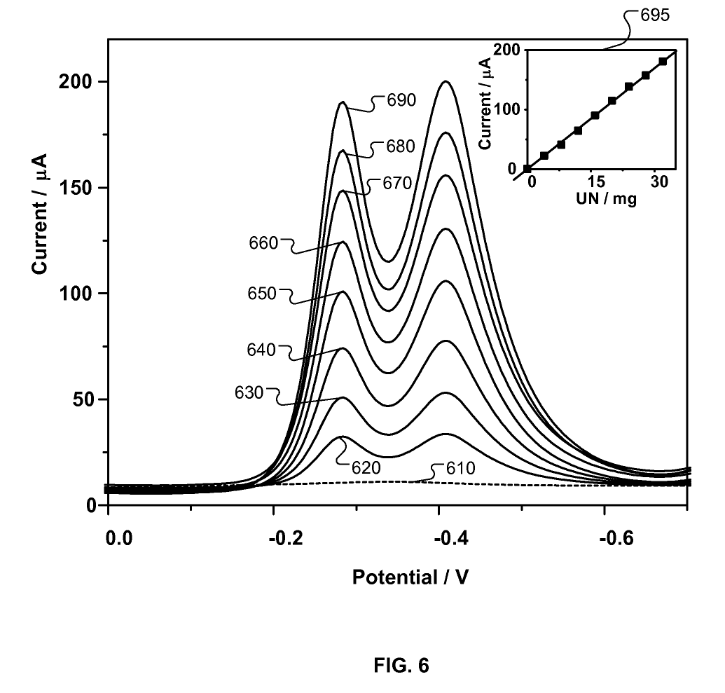

In addition, the heights of the first peak 502 for the tested chemicals offer convenient and reliable quantization of solid UN. For example, FIG. 6 displays voltammograms for increasing amounts of UN in 4 mg increments. Well-defined peaks with amplitudes (current level) proportional to the amount of UN, are observed for a range of UN amounts including 0 mg (610), 4 mg (620); 8 mg (630), 12 mg (640), 16 mg (650), 20 mg (660), 24 mg (670), 28 mg (680), and 32 mg (690). A linear relationship between the current level and the UN amount (over the entire 4-32 mg range) is shown in the inset 695 of FIG. 6.

Such effective operation of the electrochemical (carbon-electrode) transducer in strongly acidic media may eliminate the need for an additional neutralization process required in UN assays that uses acid-induced pigment-based optical techniques. Thus, the detection process is simplified to a single process (without the neutralization process). In addition, the electrochemical detection process as described in this specification can be implemented to detect various amounts of explosive materials. For example, significantly larger or smaller amounts of UN can be detected than possible with standard assays, such as the pigment-based assay. Further, the detection process can be carried out much faster than other assays, such as the pigment-based assay.

A pigment or color-based test can require up to one minute in processing time and is limited to detecting microgram amounts of UN. This reflects the slow reaction and acidic character of UN that restricts the operation of the color pigment at high levels of UN. The pretreatment process for the electrochemical assay as described in this specification can require as little as 10 sec (without any preheating or cooling) and the subsequent electrochemical (potential) scan (i.e., voltammograms) may takes up to 2 additional sec. Such speedy detection can be attributed to the fact that only easily reduced nitroaromatic compounds (including DNT itself) are expected to yield a response within the potential window of interest. When such response is detected, the detection system 100 can be designed to actuate an alarm reflecting the presence of military explosives. In addition, the detection process can be performed with and without the NT reagent. Subtracting the two signals (with and without the NT), the response associated only with the specific reaction of UN can be determined.

In some implementations, factors affecting the sample collection of target material, desorption efficiencies, and the speed and efficiency of the acid pretreatment reaction of various explosive material can be examined and optimized. In particular, the effect of the concentration/amount of NT and sulfuric acid (in the reagent solution) and to the reaction time and conditions (volume, shaking mode, etc.) can be examined. Systematic optimization of the pretreatment process, for example, can further shorten the reaction time (i.e., less than 10 sec period ) and can lead to enhanced sensitivity and operator's security. Further, various parameters of the sensor unit 120 and the reader 130 can be varied. For example, parameters of the electrodes (in the sensor unit 120) can be varied during fabrication (type of carbon ink, and its curing temperature or time). Also, the parameters of the square-wave voltammetric scan (frequency, step, amplitude) for the reader 120 can be varied. Further, various conditions of the reagent solution (pH, medium, volume) and the effect of those conditions upon the sensitivity, speed and shape of the DNT detection response can be determined.

In some implementations, the detection system as described in this specification can be tested and validated under relevant screening scenarios (indoor and outdoor) and environmental conditions. The overall performance (“figures of merit”) and robustness of the new detection system 100 can be critically examined. The ability of the detection system 100 to sample, detect and identify target materials, such as UN, under different civilian and military monitoring scenarios can be tested. The ability of the detection system 100 to differentiate target materials, such as UN, from common nonexplosive background materials can be determined. For example, the detection system 100 can be implemented to differentiate UN from harmless materials likely to be present in urban, industrial, agricultural, airport, etc. environments (e.g., sugar, salt, urea and urea compounds, fertilizers, soap, soil). Particular attention can be given to the Pd and FAR in various matrices, to the dynamic range (up to 100 mg UN) and the detection limit. The integrated sampling/detection system 100 can be implemented in laboratory settings, simulated lab-fields, and experimentation at government agencies test sites, according to the test plan, safety protocol and live tests under relevant scenarios.

The detection system described in this specification can be implemented to provide convenient and reliable detection/measurement of target explosive materials (e.g., solid UN) over a wide (2-35 mg) range. For example, the detection/measurement can be performed by coupling a short (˜10 sec) acid-catalyzed reaction of UN with 4-nitrotoluene (NT) and rapid (˜1-2 sec) electrochemical (voltammetric) detection of the 2,4-dinitrotoluene (2,4-DNT) product. Quantification of the target material can be determined based on the direct dependence between the electrochemical signal (reduction current of 2,4 DNT) and the target material concentration. The ability to operate in harsh acidic conditions allows adjustment of the sensitivity to a wide range of target material levels.

Electrochemical Detection of Peroxide-Based Explosives

The detection system 100 as described in this specification can be implemented to detect other target materials. For example, peroxide-based explosives can be detected based on electrochemical measurements at an electrode modified by an electrocatalytic material. In particular, the sensor unit 120 of the detection system 100 can be designed to include one or more Prussian-blue (PB) modified electrodes as the electrode leads 125, 126, 127. Electrochemical measurements are obtained by taking amperometric measurements at the one or more Prussian-blue (PB) modified electrodes. In electrochemical analysis, amperometric measurements provide current levels that are proportional to the concentration of the species generating the current. Prussian blue electrodes enable a highly selective low-potential stable electrocatalytic detection of hydrogen peroxide. The high selectivity of PB reflects the effective and preferential electrocatalytic activity of PB towards the hydrogen peroxide reduction that facilitates a low potential (˜0.0 V) detection where unwanted reactions of co-existing compounds are negligible. The high catalytic activity of PB leads also to a very high sensitivity towards hydrogen peroxide. To a certain extent, the behavior of PB-modified electrodes resembles that of peroxidase-based enzyme electrodes, and hence PB can be implemented as “artificial enzyme peroxidase”. PB electrodes can provide improved stability and cost advantages over peroxidase biosensors. In addition, PB electrodes can be implemented as effective electrochemical transducers for hydrogen peroxide. Other effective electrocatalysts for hydrogen peroxide such as graphite, platinum, gold, carbon, etc. can be used instead of PB.

In some implementations, the electrodes for the electrochemical sensor unit 120 can be implemented using electrode materials other than conventional electrode materials (platinum, rhodium, etc,) can be used. For example, a peroxide metalized carbon electrode (e.g., rhodium particles dispersed in graphite ink) with surface coatings other than PB (e.g., porphyrins or phtalocyanines) can be used.

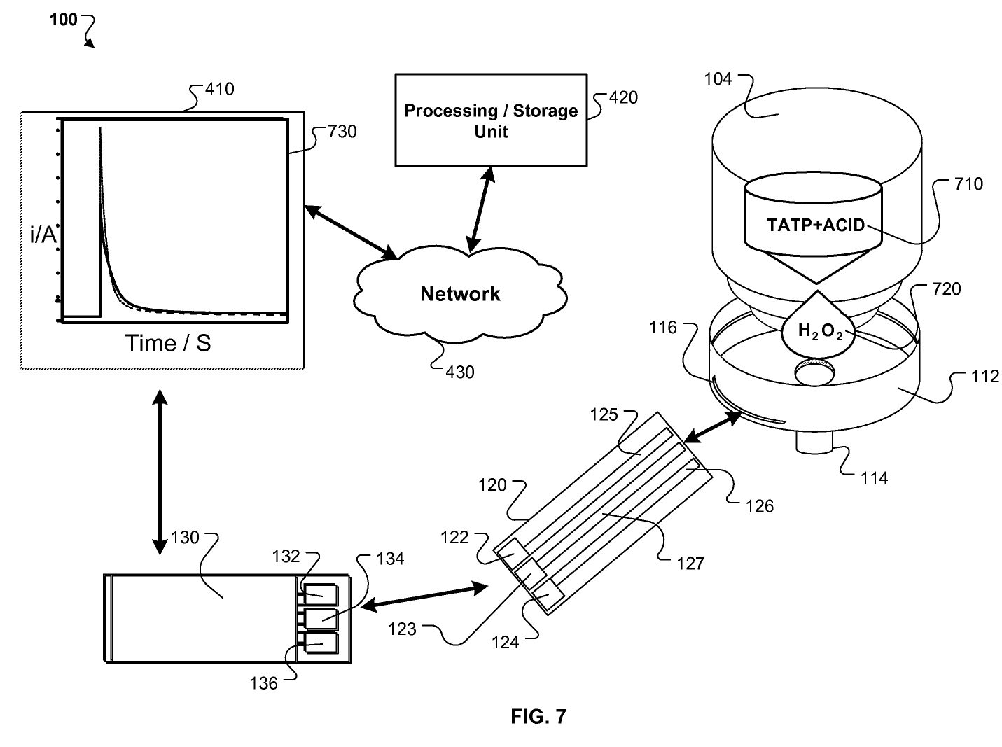

FIG. 7 shows a block diagram of the detection system 100 designed to detect peroxide-based explosive. Electrochemical detection of peroxide-based explosive is performed based on the amperometric detection of chemically-generated hydrogen-peroxide at a PB-modified carbon electrode. The sample gathering unit (a sampler) 110 is used to obtain a sample of a target material that could include a peroxide-based explosive. For example, when a peroxide-based explosive, such as triacetone triperoxide (TATP) is present in the target material, the TATP introduced into the reaction compartment (sample holding unit) 112 is mixed with an acid-reagent mixture from the reagent holding unit 114. The combination of TATP and the acid-reagent mixture results in generation of hydrogen peroxide (H₂O₂) 720 as the product of the chemical reaction between TATP and the acid-reagent mixture. The acid-reagent can be used to enable a chemically induced breakdown of the peroxide. The generated hydrogen peroxide is detected at the sensor unit 120 as amperometric currents. The reader 130 reads the detected current and outputs the read current as amperometric traces 730. The generation of hydrogen peroxide is detected at a PB-modified electrode (one or more of the electrode leads 125, 126, 127) of the sensor unit 120.

The sample gathering unit 110 can be designed to obtain a sample of a powder, solid, or a liquid to be tested in a user independent manner. Obtaining the sample can be carried out using techniques including, but not limited to, the use of a cotton or cellulosic fabric, polyimide swab, solid phase micro extraction (SPME), etc. Other sampling techniques that enable a user to obtain visual and/or trace quantities of compound/material that can be measured and detected can be used. In some implementations, the sensor unit 120 can be coupled to an automated nano-needle sampling unit (not shown) to enable high throughput sensing of the closed reaction compartment (sample holding unit) 112.

The reaction used to detect peroxide-based explosives takes place in the reaction compartment (sample holding unit) 112. After the sample is introduced to the reaction compartment (sample holding unit) 112, the reaction compartment (sample holding unit) 112 is sealed and the reagent holding unit 114 (e.g., an ampoule) broken to release a mixture of acid and organic solvents and introduce the mixture to the sample material in the reaction compartment (sample holding unit) 112. The sample gathering unit 110 and the reaction compartment (sample holding unit) 112 is designed as a polymer (e.g., a plastic) container. However, other materials that can form a chamber for the reaction environment can be used (e.g., glass, metal, etc.) In some implementations, a pigment can be added to the acid-solvent mixture in order to enable visual confirmation of the ampoule break. The combination of the sample gathering unit 110 and the reaction compartment (sample holding unit) 112 is designed as a single use, disposable unit.

Chemicals and Reagents

Acetonitrile can be obtained from Mallinckrodt (Phillipsburg, USA). TATP and HMTD solutions (0.1 mg/mL in acetonitrile) can be obtained from AccuStandards (New Haven, USA). Deionized water obtained from a Milli-Q system (Millipore, Bedford, Mass.) can be used to prepare all solutions. Potassium ferricyanide, iron(III)-chloride, potassium chloride, potassium hydroxide, monobasic and dibasic potassium phosphates can be obtained from Sigma-Aldrich (St Louis, USA). Horseradish peroxidase and ferrocenemethanol can be obtained from Aldrich. Hydrochloric acid (12 M) can be obtained from EMD (Darmstadt, Germany). Stock solutions of hydrogen peroxide is prepared by diluting a 30% (m/v) H₂O₂ standard solution (Fischer Scientific, Fair Lawn, USA).

Electrocatalyst (Prussian-Blue) Electrodeposition

Reactions involving peroxide-based explosives are performed using Prussian blue as the artificial peroxidase electrocatalyst. However, PB is used by way of example only, and other electrode modifications can also be used.

The PB ‘artificial peroxidase’ is a highly active, selective and stable electrocatalyst for hydrogen peroxide. Compared to a bare electrode surface without an electrocatalyst, PB enables a highly selective and sensitive peroxide detection by substantially lowering the over-voltage condition for the hydrogen peroxide redox process. Thus, PB is an efficient hydrogen peroxide transducer that facilitates the rapid detection of peroxide explosives down to the nanomolar level. The powerful electrocatalytic action of PB can enable a convenient measurement of trace levels of peroxide explosives. Such measurement is based on the linear relation between the magnitude of the reduction current and the concentration of the peroxide explosive compound.

PB modified electrodes are prepared by deposition. A glassy carbon electrode (GCE) is polished with a 0.05 μm alumina slurry until a mirror finish is observed. The deposition solution contained 4 mM K3[Fe(CN)6] and 4 mM FeCl3, in a 0.1 M KCl/0.1 M HCl supporting electrolyte solution. A Prussian-blue film is deposited for 60 sec using a constant potential of +0.4 V (under stirring). After PB deposition, the PB film is ‘activated’ in the same electrolyte solution by cycling the potential over the −0.05 to 0.35 V range at 40 mV s⁻¹ for 400 sec (20 cycles). Other chemical volumes and other processing conditions, such as time, voltage and cycling can be varied/used to fabricate electrodes modified by an electrocatalyst or artificial peroxidase enzyme.

The PB deposition on screen-printed electrodes can be performed in a similar fashion except that a longer deposition time of approximately 120 seconds (instead of approximately 60 sec) is implemented at +0.4V. In addition, the surface of the electrode is activated with 20 voltammetric cycles at 40 mV s⁻¹ over the −0.2 V to 0.40 V range (vs. pseudo Ag/AgCl), and the deposition/activation steps are repeated one more time.

In some embodiments, instead of coating an electrode with an electrocatalyst, an electrocatalyst such as PB can be dispersed in the ink for screen printing an electrode, allowing for one step preparation of a modified electrode.

Acid Conversion of TATP: Amperometric Measurements after Neutralization

Electrochemical detection of TATP is validated by analyzing the reaction of TATP with an acid-based reagent using the detection system 100. For example, a 20 μL aliquot of 450 μM TATP (in acetonitrile) is mixed with 20 μL of 6 M HCl solution in the reaction compartment (sample holding unit) 112 and the mixture is shaken vigorously for 15 seconds. A 40 μL aliquot of a 3 M KOH solution is added immediately to the TATP-HCl mixture, followed by 5 sec mixing. An appropriate aliquot (of 20 to 40 μL) of this solution (TATP+HCl+KOH) is added to a stirred 2 mL phosphate buffer (pH 6.0, 0.05 M)/0.1 M KCl solution. Control reactions are performed similarly using pure acetonitrile solutions without TATP.

Amperometric measurements of hydrogen peroxide released as a result of the reaction between TATP and the acid-based (e.g., HCl) reagent (performed under stirring) are detected by the PB-modified GCE transducer (e.g., the sensor unit 120 having PB-modified electrodes). The PB-modified GCE transducer detects the amperometric measurements in response to an working potential (usually 0.0V vs. Ag/AgCl [3 M KCl]) applied through the working electrode. The transient current is allowed to decay to a steady-state value before spiking a given aliquot of the acid-treated explosive solution. Noise filtration is carried out using the CHI software smoother (in the ‘least square smoothing’ mode 7 points), for example.

Acid Conversion of TATP: Amperometric Measurements Without Neutralization

Solid samples (microgram amounts) of a target peroxide explosive materials are obtained by drying standard solutions of the materials in acetonitrile solvents. For example, a 100 μL aliquot of 100 ppm HMTD or TATP is placed in a 200 μL vial and the acetonitrile solvent is allowed to evaporate over 10 hours in a rate of 10 μL/hr. The presence of the explosive crystals can be verified using optical microscope of Caltex Systems. A 20 μL aliquot of a 0.5 M HCl solution (containing 0.1 M KCl) is added into the vials containing the solid TATP and then vigorously shaken for 1-5 minutes. Subsequently, the 20 μL-droplet containing the generated hydrogen peroxide is dispensed as a droplet onto the screen-printed electrode, assuring coverage of the three-electrode area of the sensor unit 120. After 50 seconds, the potential applied is stepped to 0.0V and the current transient is sampled after 100 seconds. Control chronoamperometric experiments are carried out using a 0.5 M HCl/0.1 M KCl solution. The PB-modified screen-printed electrodes are first evaluated using 20 μL droplets of standard hydrogen-peroxide solutions, diluted in the same acidic electrolyte (0.5 M HCl containing 0.1 M KCl).

A simplified and reliable detection of peroxide-based explosives is implemented using a combination of a fast acid conversion of a peroxide-based explosive to hydrogen peroxide and a highly active, sensitive, selective and stable PB electrocatalytic transducer. For example, hydrochloric acid (HCl) is used with the PB-modified electrodes, along with potassium chloride (KCl) added to a phosphate buffer. However, the buffer can be left out, for example, when using strip electrodes with droplets of a solution under test. In addition, other acids can be used to enable conversion of peroxide explosives to hydrogen peroxide. Examples of acids include nitric, hydrochloric, perchloric, phosphoric acids, etc.

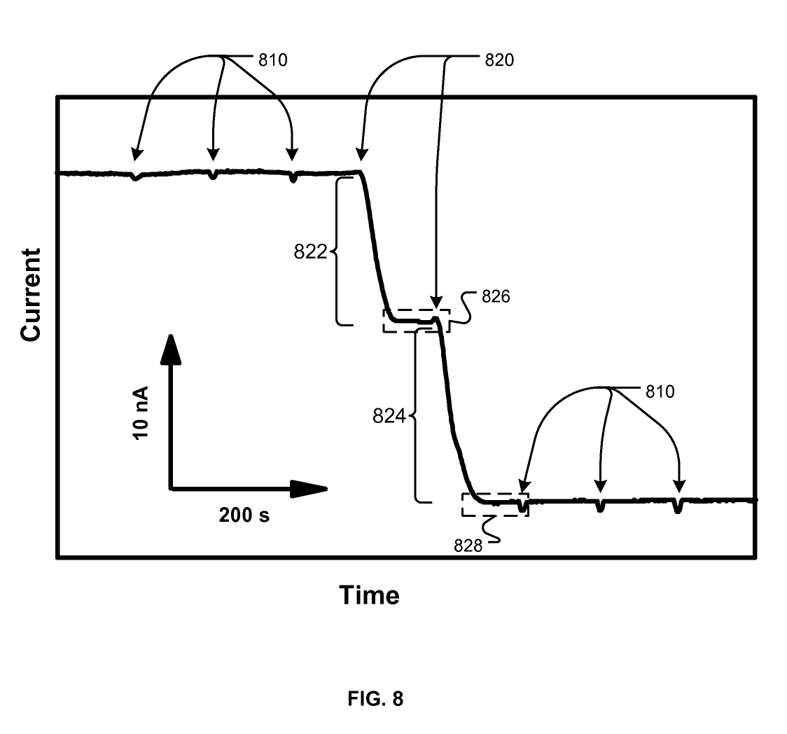

The optimal conditions for the HCl treatment of TATP are assessed in connection to a KOH-based neutralization process at a PB-coated glassy-carbon electrode of the sensor unit 120. FIG. 8 illustrates the amperometric response for TATP following an acid conversion and neutralization. In particular, FIG. 8 displays current-time recordings obtained at the PB-modified glassy-carbon electrode (operated at 0.0V) upon three additions of a blank solution (pure acetonitrile acid treated) 810 and two additions of a 2 μM TATP solutions 820. Twenty microliters of the 450 μM TATP solution (in acetonitrile or of pure acetonitrile in case of blank) are vigorously shaken with 20 μL 6 M HCl for 15 sec followed by a neutralization process with 3 M KOH solution. Amperometric signals are recorded for additions of 30 μL of the final treated sample into the 2 mL 0.05 M phosphate buffer (pH=6.0) containing 0.1 M KCl, thus corresponding to a final concentration of 2 μM TATP. While no response is observed for the ‘control’ (blank) acetonitrile additions, the PB-modified glassy-carbon electrode responds rapidly to additions of the TATP analyte. Well defined reduction currents 822, 824 and steady-state responses 826, 828 within ˜30 seconds in connection to an acid treatment (of 10 sec) and approximately 5-10 seconds neutralization. H₂O₂ acid-generated was detected at the Prussian-blue modified glassy-carbon electrode of the sensor unit 120. Potential applied is fixed at 0 mV through a Ag/AgCl (3 mol L⁻¹ KCl).

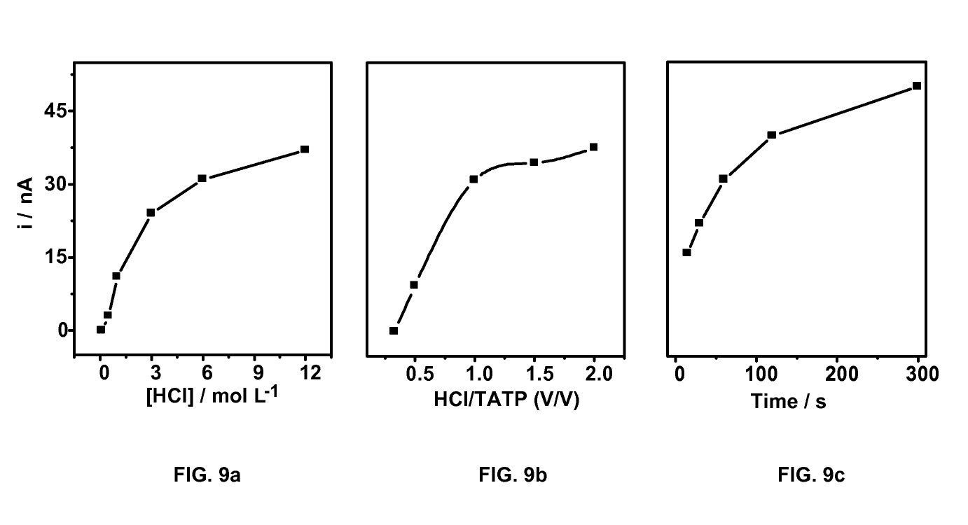

FIGS. 9a, 9b and 9c show the factors affecting the efficiency of the acid treatment of TATP that are optimized. FIG. 9a illustrates optimization of the acid decomposition of TATP in various HCl concentrations. The optimal HCl concentration is determined to be 40 μL of 1:1 (v/v) HCl/TATP shaking for 30 sec. FIG. 9b illustrates optimization of the acid decomposition of TATP using various HCl/TATP volumetric ratios. The optimal ratio is determined as 6 M HCl with 30 sec shaking. FIG. 9c illustrates optimization of the acid decomposition of TATP using various acid treatment times. The optimal time is determined as 60 sec. of shaking time at 40 μL of 1:1 (v/v) 6M HCl/TATP. Concentration of the peroxide-explosive is 2 μM.

The effect of the acid concentration on the response of the hydrogen-peroxide product is shown in FIG. 9a. Higher acid concentration resulted in higher conversion of TATP to hydrogen peroxide. The current (Y-Axis) increases rapidly between 0 and 3 M HCl, and more slowly thereafter. FIG. 9b shows the effect of the TATP/HCl volume ratio upon the hydrogen peroxide signal (measured as current). The current signal increases upon increasing the TATP/HCl volume ratio between 0.3 and 1.0, and nearly levels off at higher ratios. Dilution of the TATP sample has a minor role compared to the need for larger amount of HCl. A large molar ratio between the H+ ions (from the acid) and TATP can enable effective conversion of microgram quantities of TATP to H₂O₂. For larger amounts of peroxide-based explosive, the ratio can be reduced. The influence of the acid-treatment time upon the current response is shown in FIG. 9c. The current increases rapidly between 30 and 60 sec pretreatment times and slowly above 120 sec pretreatment time. Thus, the optimal conditions for TATP detection includes a 6 M HCl concentration, a volume ratio of 1.0 (v/v) and a 60 sec mixing time. The 6 M HCl concentration and 60 sec treatment offer a good tradeoff as they yield ca. 65-80% of the maximal signal.

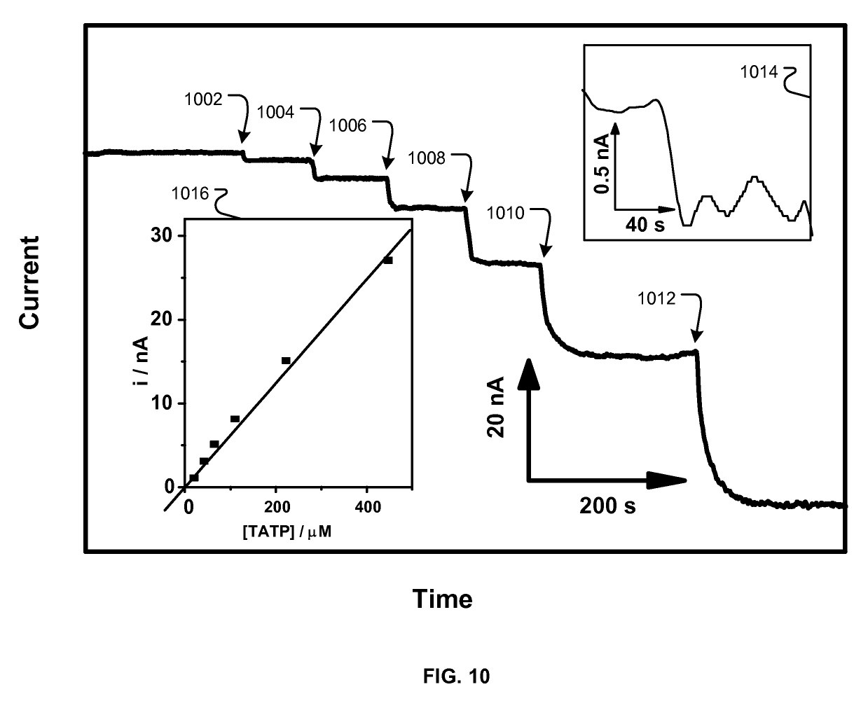

FIG. 10 displays the amperometric response of the PB-modified glassy-carbon electrode upon adding 40 μL of the acid-treated (and neutralized) TATP samples of increasing concentrations. In particular, current-time amperogram are shown for increasing concentrations of TATP including 20 μL of 22.5 μM (1002); 45 μM (1004); 67.5 μM (1006); 112.5 μM (1008); 225 μM (1010); and 450 μM (1012) TATP treated with 20 μL of a 6 M HCl solution for 60 sec shaking. The acid treated TATP solution is neutralized with 40 μL 3 M KOH. Aliquot of 20 μL each solution is added in 2 mL 0.05 M phosphate buffer and 0.1 M KCl, pH 6.0.

Well defined current signals are observed for TATP over the entire concentration range. The resulting calibration plot (shown as inset 1016) is highly linear (coefficient of correlation, R=0.997), with a slope of 0.062 nA/μM. Note that the actual TATP concentrations in the electrochemical cell are 400 fold lower (i.e., 55-1125 nM) considering the various dilution steps (in the electrolyte solution and due to the acid-treatment and neutralization). Based on the data of inset 1014, the estimated detection limit (S/N=3) for TATP at a PB-modified GCE after acid-treatment and neutralization is 11 μM (50 ng per 20 μL of sample). This corresponds to 27 nM TATP in the electrochemical cell, considering the various dilutions. Analogous measurement of HMTD yields a similar amperometric profile, with a detection limit of 4 μM (not shown).

The TATP response following the acid treatment is compared with that following UV irradiation. A 6-fold larger current is obtained for 2 μM TATP additions following a 15 sec acid treatment, compared to that following a 5 min UV irradiation (not shown).

Acid-Conversion of TATP: Chronoamperometric Measurements Without Neutralization

In another aspect, a direct electrochemical measurements of the hydrogen peroxide product in strong acidic medium without the additional neutralization process is disclosed. By eliminating the neutralization process, effective electrocatalytic activity of the PB sensor (sensor unit 120) in strongly acidic media is accomplished.

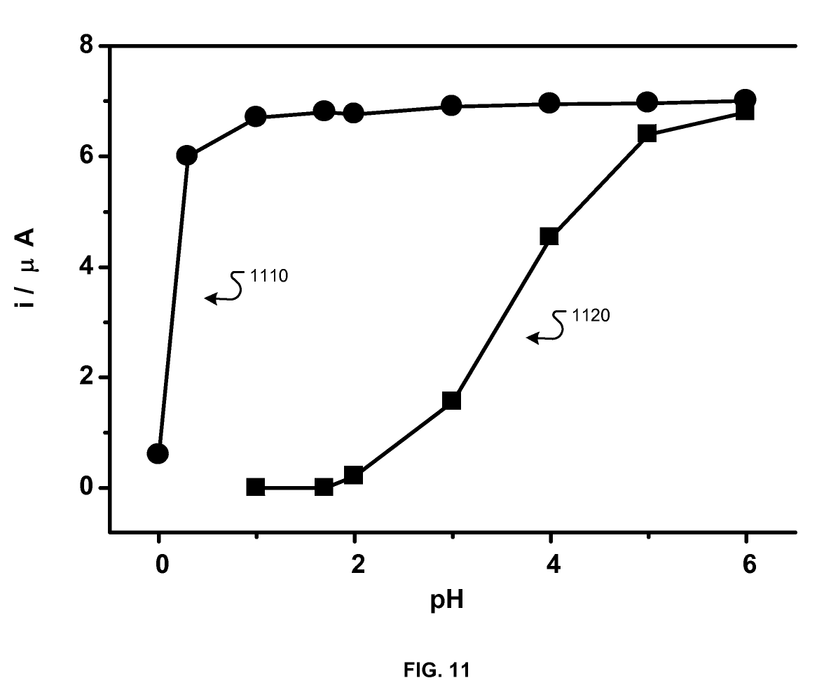

FIG. 11 illustrates the influence of the pH upon the H₂O₂ chronoamperometric response at a Prussian-blue modified GCE 1110 and at a bare GCE 1120 in the presence of 10 ppm horseradish peroxidase and 50 μM ferrocenemethanol. Currently measurements are obtained after a 5-min dipping in the indicated pH medium containing 0.1 M KCl. Applied potential step are varied from +400 mV to 0 mV (vs. Ag/AgCl). Current is sampled for 50 sec. The pH-dependence profiles shown in FIG. 11 demonstrate the advantages of a PB-modified electrode included in the sensor unit 120. For example, the advantage of the PB-modified electrode over a peroxidase assay and of the acid-treated TATP. For acid-induced enzyme deactivation processes, the bare GCE sensor loses all of its activity under extremely low pH values used for the acid treatment of TATP. The response of the bare GCE sensor decreases gradually upon lowering the solution pH between 6 and 2 and disappears completely at lower pH values. The current values at pH 3 and 4 correspond only to 23% and 64% of the highest value at pH 6. In contrast, the PB-modified electrode sensor displays only a negligible variation of the peroxide response over the pH 1-6 range, reflecting its operational stability under strong acidic conditions. A small (˜10%) decrease in the response is observed at pH 0.3. Based on the profile of the PB-modified electrode sensor 1110, a 0.5 M HCl concentration (pH 0.3) is selected (without neutralization). Note that such acid concentration yields a lower conversion efficiency compared to when 6M HCl is used along with a neutralization process.

In another aspect, to promote cost-effective field operation, the glassy-carbon disk electrode is replaced with low-cost mass-producible single-use screen-printed carbon electrodes. The neutralization process (and related storage and injection issues) common to analogous peroxidase assays can be eliminated and a disposable PB-electrocatalytic sensor is implemented in the sensor unit 120 to facilitate a greatly simplified (‘Add and Detect’) protocol for used with the detection system 100. The simplified protocol is based on placing a small quantity (for example, a 20 μl droplet) of the acid-treated sample on the PB-coated strip electrode and applying a potential step for chronoamperometric measurement of the liberated peroxide (in a manner analogous to single-use glucose diabetes testing strips). The PB-modified screen-printed electrode displays a similar pH dependence (1110) as its glassy-carbon counterpart.

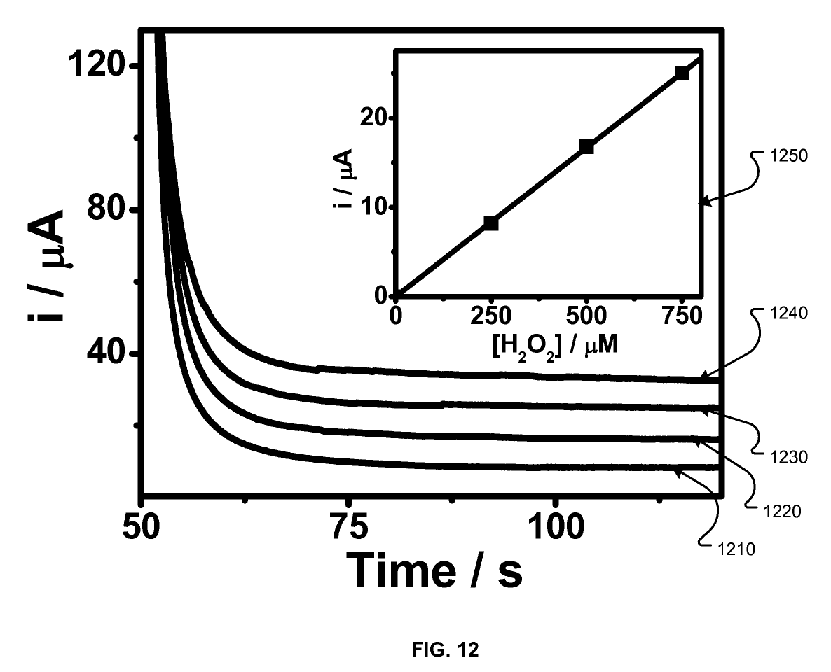

Before applying to solid TATP sensing, the disposable PB-modified screen-printed electrode is tested for chronoamperometric measurements of hydrogen peroxide in 0.5 M HCl solution (containing 0.1 M KCl). FIG. 12 displays current-time chronopotentiometric recordings for a blank (0.5 M HCl containing 0.1 M KCl) 1210 and increasing additions of H₂O₂ concentrations including 250 μM (1220), 500 μM (1230), and 750 μM (1240) at a Prussian-blue modified screen-printed electrode. Applied potential step is to 0 mV (vs. pseudo Ag/AgCl), and the current is sampled for 100 sec. The inset 1250 shows the respective calibration curve for the applied concentrations of H₂O₂ (slope=0.034 μA μM−1; coefficient of correlation, R=0.999).

The current-time chronoamperometric recordings are shown for 20 μl droplets containing increasing concentrations of hydrogen peroxide in 250 μM steps (1220, 1230, 1240), along with the corresponding background (0.5 M HCl/0.1 M KCl) response 1210. Well-defined chronoamperometric signals are observed for these sub-millimolar peroxide concentrations (1220, 1230, 1240) in the acidic medium. The current (sampled after 50 seconds) is proportional to the peroxide concentration tested. The resulting calibration plot (shown in the inset 1250) is highly linear (coefficient of correlation, R=0.999) with a slope of 34 nA/μM.

A series of 8 screen-printed electrodes (from the same printing batch) is used for assessing the reproducibility of the chronoamperometric hydrogen-peroxide response in the 0.5 M HCl solution. A relative standard deviation of 8% can be achieved for droplets containing 1 mM hydrogen peroxide. Such precision reflects potential variations in the PB depositions and the printing of the carbon transducers.

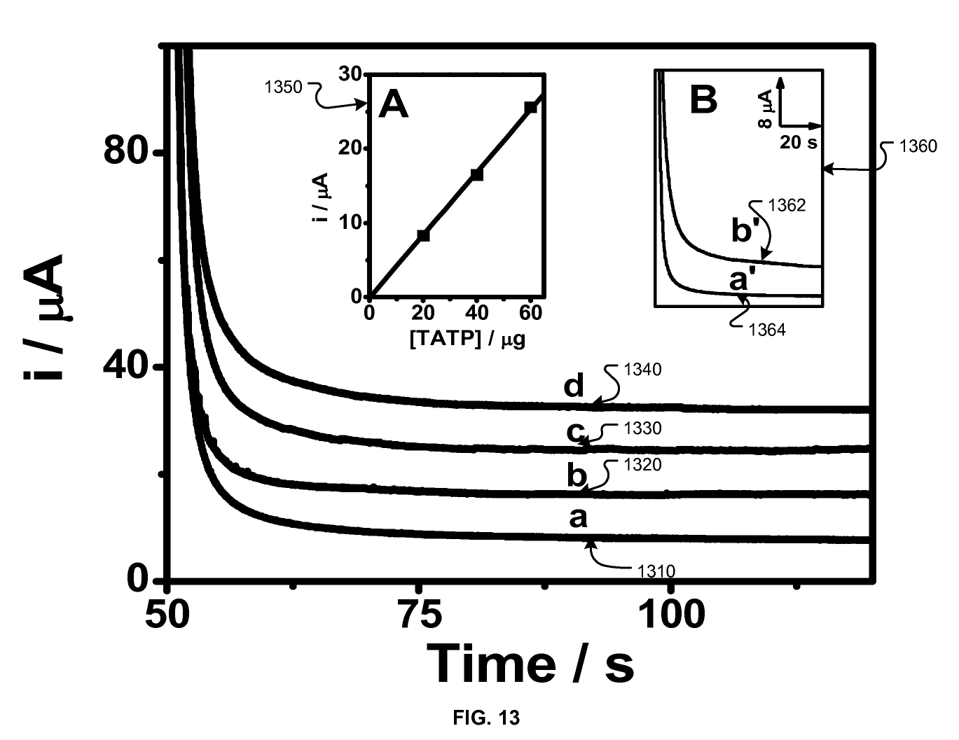

FIG. 13 demonstrates detection of trace solid amounts of TATP. Current-time chronoamperometric recordings are obtained at the PB-modified screen-printed electrode for 20 μL 0.5 M HCl/0.1 M KCl droplets containing increasing amounts of TATP powder including 20 μg (1320), 40 μg (1330) and 60 μg (1340). The various TATP concentrations 1320, 1330, 1340 are compared to a blank (background) sample (no TATP added) 1310. Well defined current transients, proportional to the amount of TATP are observed following a 5 min acid treatment. The resulting calibration plot (left inset 1350) is highly linear (coefficient of correlation, R=0.999), with a slope of 0.421 μA/pg (2 μA/mM). Note that significantly higher (mg) amounts of TATP are used in connection to the peroxidase-based assay of acid-treated TATP. Also shown in FIG. 13 (right inset 1360) is the corresponding chronoamperometric response to 80 μg TATP acid-treated TATP following a 1 minute treatment 1362, along with the corresponding background signal (no TATP) 1364. These data demonstrate the ability to detect low (micrograms) amounts of solid TATP following a short one-step pretreatment time (and without neutralization). An even larger (4-fold) response was observed for analogous measurements of HMTD (not shown).

The high sensitivity and selectivity associated with such low-potential electrocatalytic detection minimizes negative and positive false alarms and enhance the reliability of visual and trace detection of peroxide explosives even in complex matrices. In some implementations, the PB film applied to the electrode can be covered with a permselective (size-exclusion) coating that can further enhance the sensor selectivity, stability and overall performance. In some implementations, relevant samples may be pretreated enzymatically (with catalase) to remove the co-existing hydrogen peroxide (which can originate from materials including cleaning agents).

In some implementations, ultraviolet (UV) radiation can also be used in conjunction with chemical breakdown of liquid peroxide based explosives. For example, ultraviolet (UV) irradation of TATP and HMTD can be performed using a 500W Mercury (Xenon) Arc Lamp (Oriel, Model 68711, Stratford, Conn., USA). This UV source can provide a broad wavelength spectrum of light covering the spectral region approximately between from ultraviolet wavelengths (which can be as short as approximately 10 nm) to the near-infrared (NIR) wavelengths (approximately 3 μm). Longer infrared wavelengths can also be used. In some implementations, ultraviolet (UV) irradation of TATP and HMTD can be performed using a YAG:ND laser source (48 mJ/pulse, repetition rate, 10 Hz; Model Surelite 1, Continuum Inc., Santa Clara, Calif., USA). This laser source can emit light at wavelengths of 266, 355, 532 and 1064 nm. Alternatively, other wavelength laser sources such as the 266 nm wavelength line can be used.

In addition to lasers, other light sources such as emitting diodes (LEDs), arc lamps, fluorescent lamps and the like can also be used. These and other light sources can operate under pulsed electrical operation, or under continuous electrical operation. Further, the light source can provide illumination either as pulses of light or as a steady state continuous level of light. The above wavelengths, wavelength ranges and optical powers are given by way of example only, and other wavelengths, wavelength ranges and optical powers that can photochemically generate H₂O₂ from peroxide-based explosives to can be used.

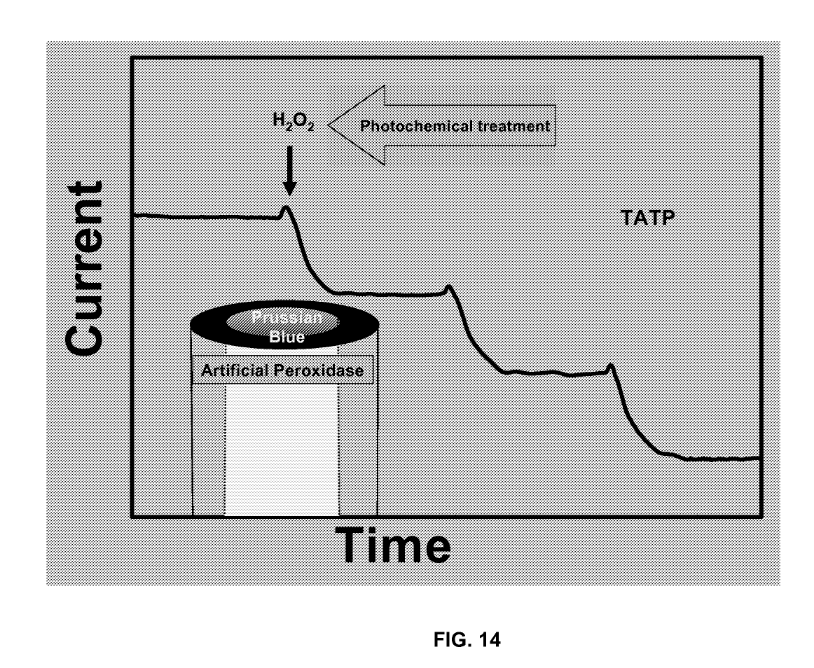

Hydrogen peroxide can be generated through the use of a light source, as described above, at an appropriate wavelength (or range of wavelengths) to photochemical-induce breakdown of the liquid peroxide-based explosives. FIG. 14 illustrates schematically an amperometric trace that can be obtained when a peroxide-based explosive is photochemically converted to Hydrogen Peroxide at a PB-modified electrode. Such a sensor can offer higher sensitivity at lower cost compared to earlier peroxidase-based explosive assays.

Amperometric measurements of peroxide-based explosives (by generating H₂O₂, in response to a light stimulus) are performed at room temperature using a stirred volume (e.g., 2 mL of the 0.05M phosphate buffer with pH of 5.97) of the reagent solution containing an acid (e.g., 0.1 M KCl). The amperometric measurements are measured in response to an application of a working potential (e.g., 0.0V). The transient current measured are allowed to decay to a steady-state value before adding a given aliquot of the UV-treated explosive solution. Noise signals can be filtered out using a filtering software, such as the CHI software smoother in the ‘least square smoothing’ mode. However, other software operating under other smoothing techniques can be used.

As described above, the PB-modified ‘artificial peroxidase’ electrode is a highly active, selective and stable electrocatalyst for hydrogen peroxide. The PB-modified electrode can enable a substantial lowering of the overvoltage for the hydrogen peroxide redox process, compared to a bare surface electrode without an electrocatalyst. Accordingly, the PB-modified electrode can enable a highly selective and sensitive peroxide sensing. Such efficient hydrogen peroxide transducer facilitates a rapid detection of peroxide explosives down to the nanomolar level. Such high sensitivity can be achieved in connection to short assay times. For example, a high intensity (˜300 W) UV lamp and a YAG:ND laser (48 mJ/pulse, repetition rate, 10 Hz) can enable an efficient photochemical generation of hydrogen peroxide using 5 min and 15 sec irradiation times, respectively.

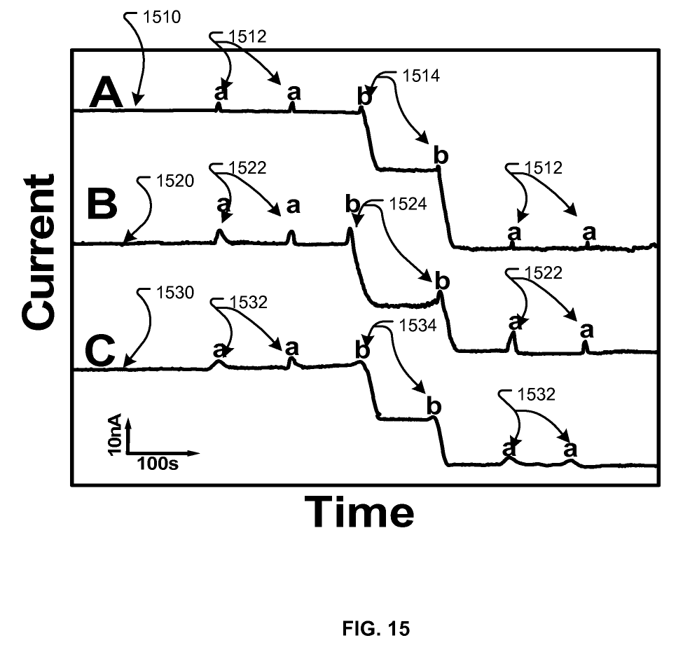

Since commercially available TATP and HMTD solutions are prepared in acetonitrile, control experiments included similar photochemical pretreatments of pure acetonitrile (to ensure that the control solution does not generate detectable products at the PB electrode). FIG. 15 shows exemplary current-time amperometric recordings obtained at a PB-modified electrode (or transducer), in response to a working potential of 0.0V, upon adding UV-treated acetonitrile (a,A,B) 1512,1522; 12 μM HMTD (b,A) 1514; and TATP (b,B) 1524 solutions. Note that no response (no electrical signal) is measured when only acetonitrile (control) is present in the sample holding unit 112. However, the sensor unit 120 (with the PB-modified electrode) responds rapidly when TATP and HMTD are added to acetonitrile to yield well-defined reduction currents and a steady-state response within ˜15 seconds of TATP and HMTD addition.

Measured current 1530 illustrates amperometric data for untreated 1532 and UV-treated 1534 TATP solutions. A supporting electrolyte (not shown) of 0.05 M phosphate buffer (containing 0.1 M KCl, pH 5.97) can be used to obtain these measurements. FIG. 15 illustrates a defined response measured only in connection to the photochemical generation of hydrogen peroxide. The data as shown in FIG. 15 indicate that a 5 min UV-lamp irradiation time may be sufficient to generate an easily detectable amperometric response for micromolar peroxide explosive concentrations. In some implementations, a laser light source can be implemented to provide the irradiation to obtain a significantly shorter (in the range of seconds) irradiation times and overall assay times in addition to a higher sensitivity.

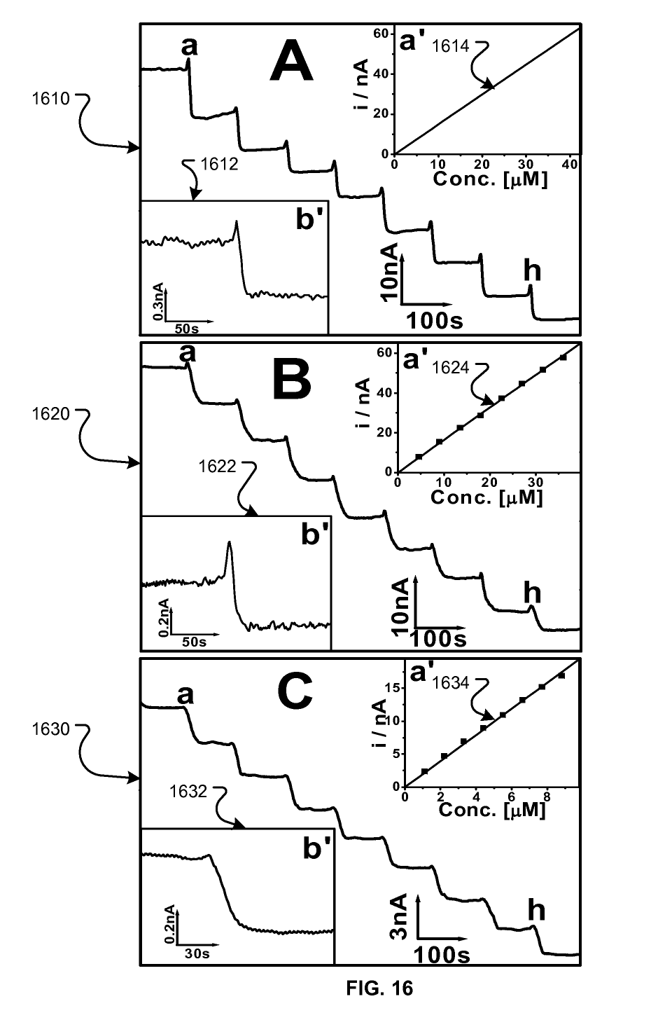

As described above, electrocatalytic action of PB can enable a convenient quantization of trace levels of peroxide explosives. Such quantization can be based on a linear relation between the magnitude of the reduction current and the concentration of the peroxide-based explosive compound. FIG. 16 displays calibration data obtained based on eight successive 4.6 μM additions of HMTD 1610 and TATP 1620, as well as for 1.0 μM TATP additions 1630, in connection to the 5 min UV-lamp (1610, 1620) and 15 sec laser (1630) irradiations. Well defined current signals are measured for both explosives (TATP and HMTD) over the entire concentration range tested. The resulting calibration plots for 1610, 1620 and 1630 (shown as insets a′ 1614, 1624 and 1634) are highly linear, with slopes of 1.51, 1.64, 1.98 nA/μM for 1610, 1620 and 1630 respectively.

FIG. 16 (insets b′ 1612, 1622, 1632) also illustrates the corresponding current signals for 1 μM additions of TATP 1610, and HMTD 1620, as well as for a 200 nM addition of TATP 1630. The well defined response (electrical current signal) for such low concentration of both explosives indicates the low detection limits of 50 nM (11 ppb) TATP using the short laser treatment, or 0.25 and 0.30 μM TATP and HMTD (i.e., 52 and 67 ppt), in connection to the 5 min UV-lamp irradiation. Such values for the detection limits are significantly lower than for the peroxidase-based optical assays (micromolar detection limits) following a UV treatment. In addition, the data as shown in FIG. 16 indicates that the higher intensity of the laser pretreatment (irradiation) may enable higher sensitivity, a lower detection limit, and substantially shorter irradiation times (1630 vs. 1610, 1620).

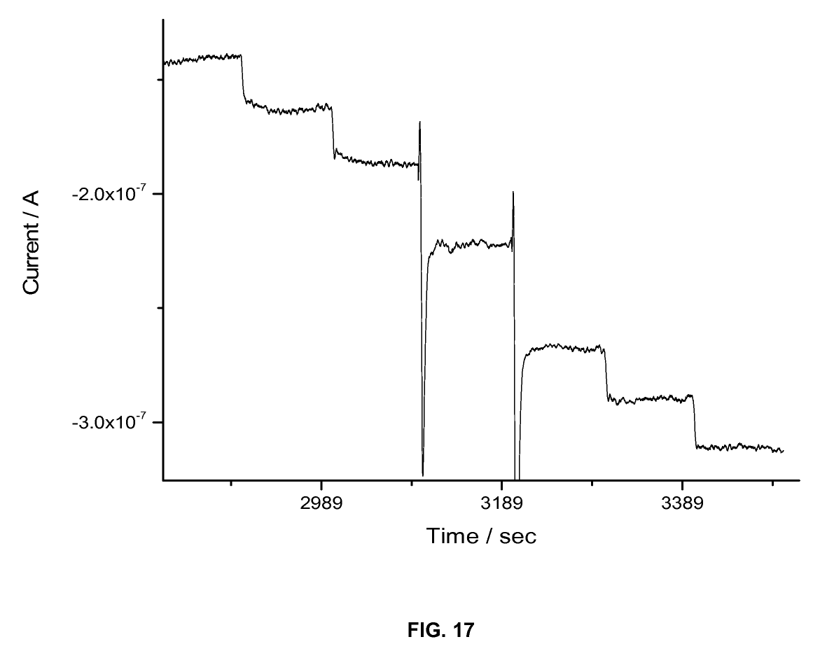

FIG. 17 illustrates a comparison of the amperometric response of TATP with that of a standard hydrogen-peroxide solution. Conversion efficiencies of ca. 50% and 60% (mol H₂O₂/mol peroxide explosive) are obtained for the 5 minute UV-lamp irradiation and the 15 second laser treatments, respectively. No response is obtained for the laser-treated acetonitrile solution (control solution). The highly sensitive response of the PB-modified electrode is coupled with high stability, characteristic of ‘artificial-peroxidase’ transducers.

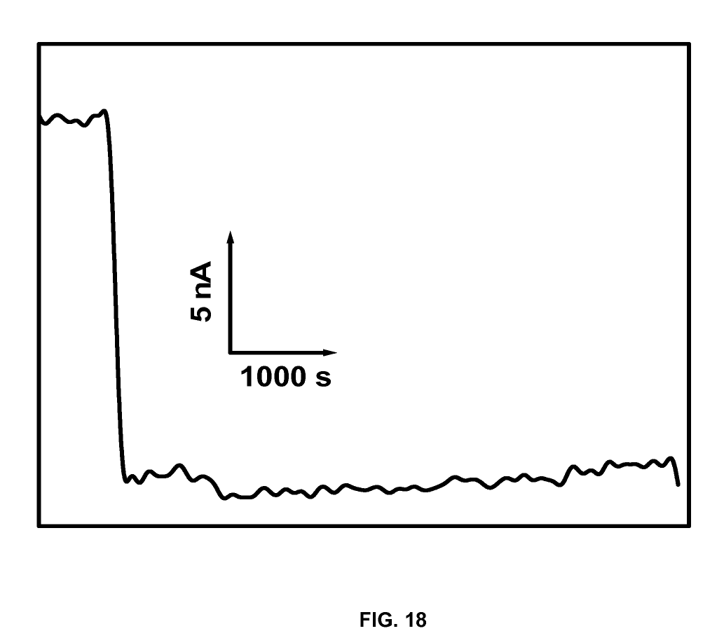

FIG. 18 displays the amperometric response for 12 μM TATP over a prolonged 2.5-hour continuous operation with 5 min UV irradiation. A highly stable response is obtained with no apparent signal loss. The sensitivity and exposure time may depend on one or more of (1) light source wavelength or wavelength range, and (2) the power (or energy) of the light source. In some implementations, other electrode voltages may be used.

In some implementations, the detection system 100 can be designed to avoid false positive. Some materials may already include hydrogen peroxide in the background. For example, laundry detergent powders with oxygen bleach may contain perborate or percarbonate, which liberate hydrogen peroxide upon contact with water. This may lead to a false positive result for peroxide-based explosives. To avoid such false positive detection, a selectivity process (e.g., with a catalase to reduce a possible hydrogen peroxide background) can be implemented.

Various implementations have been described for a simple, low-cost and sensitive electrochemical assay for monitoring trace levels of peroxide-based liquid explosives based on the use of a PB-transducer for measuring the photochemically generated hydrogen peroxide. Such electrochemical detection offers great promise for meeting the portability, speed, cost and low-power demands of field detection of peroxide-explosives. The high sensitivity and selectivity associated with such low-potential electrocatalytic detection should minimize negative and positive false alarms and enhance the reliability of trace detection of peroxide explosives in complex matrices. Whenever needed, the PB film can be covered with a permselective (size-exclusion) coating that can further enhance the sensor selectivity, stability and overall performance. Also, when needed, relevant samples may be treated enzymatically (with catalase) to remove the co-existing hydrogen peroxide (originated from cleaning agents). The electrochemical detection system can be further developed into disposable microsensors in connection to single-use screen-printed electrode strips and an hand-held meter (similar to those used for self testing of blood glucose). The PB-transducer can be readily adapted for gas-phase electrochemical detection of trace TATP and HMTD in connection to coverage with an appropriate solid-electrolyte coating.

As describe above, the PB-modified electrodes in the sensor tend not to be prone to the extreme acidic conditions used for the treatment of peroxide explosives. In addition, the single acid-treatment as described in this specification can help to eliminate the need for an additional neutralization process common to analogous peroxidase assays. This results in a simple, rapid and sensitive one-step (“Add and Detect”) assay of TATP and HMTD that enables effective field screening of these peroxide-based explosives among others. The detection system is simple to use, requires little or no maintenance, and provides a clear output signal.

Various implementations have been described for a simple, low-cost and sensitive electrochemical assay for monitoring various explosive materials such as UN and peroxide-based liquid explosives. The detection system can be based on the use of a PB-transducer for measuring hydrogen peroxide generation. Such electrochemical detection mechanism facilitates selectivity, sensitivity, portability, speed, cost and low-power demands of field detection of various explosive materials such as UN, peroxide-explosives, and peroxide based chemicals used, for example, in manufacturing and industrial processes.

Additionally, the PB-based electrode sensor can be readily adapted for gas-phase electrochemical detection of trace TATP and HMTD in connection to coverage with an appropriate solid-electrolyte coating.

Microelectrode Sensor

In some implementations, the detection system 100 can be implemented as a microelectrode sensor. Field detection of explosive materials (substances) can be facilitated by coupling a powerful analytical performance to a miniaturized low-powered instrumentation/device. Electrochemical detection devices provide various advantages that include high sensitivity and selectivity, speed, compatibility with modern microfabrication techniques, minimal space and power requirements, and low-cost instrumentation. For example, the inherent electroactivity of nitroaromatic and nitroester compounds makes them ideal candidates for electrochemical detection.

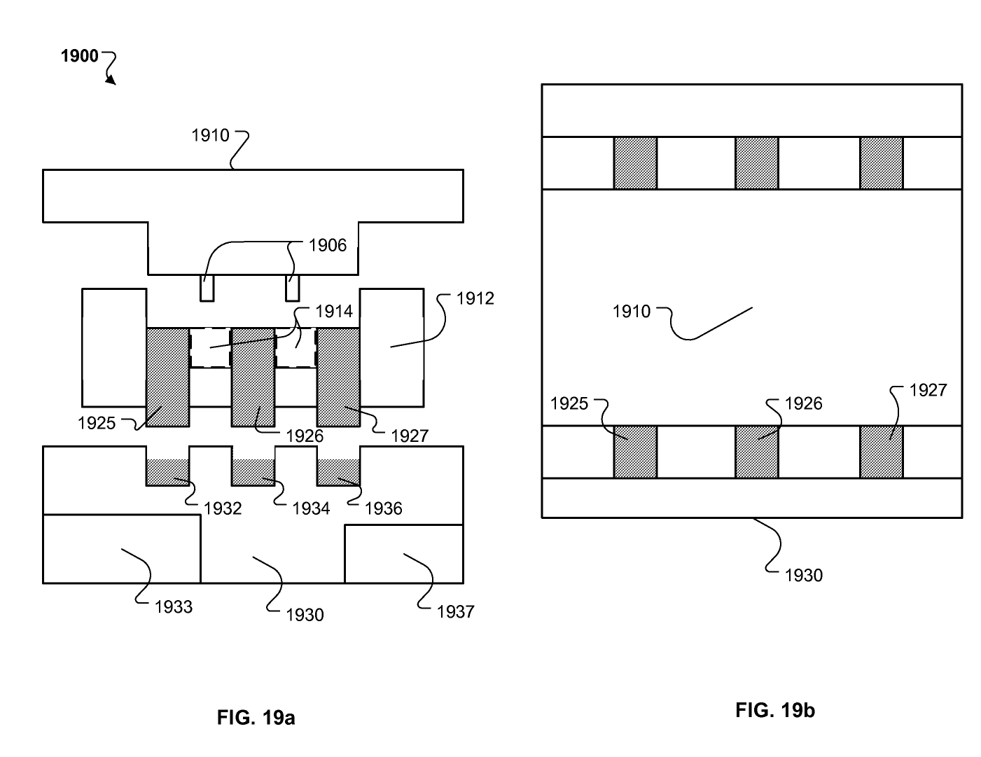

FIGS. 19a and 19b illustrate a microelectrode sensor 1900 for detecting explosive materials. FIG. 19a shows a cross sectional view of the microelectrode sensor 1900, and FIG. 19b shows a top-down view of the microelectrode sensor. The microelectrode sensor 1900 can incorporate some or all of the components of the detection system 100 as described with respect to FIG. 4 above. For example, the microelectrode sensor 1900 can be designed using a microfabricated microchip that includes the sample holding unit 112, and the sensor unit 120 built-in.

The microelectrode sensor 1900 includes a sample gathering unit 1910 that interfaces with a sample holding unit 1912. The sample gathering unit 1910 is used to obtain a sample of a target material. The sample holding unit also includes a reagent holding unit 1914 designed to hold a reagent. When the sample gathering unit 1910 interfaces (e.g., attaches) with the sample holding unit 1912, the reagent releasing unit 1906 automatically release the reagents from the reagent holding unit 1914. The released reagent mixes with the sample of the target material gathered by the sample gathering unit 110. When the target material includes an explosive material (e.g., peroxide-based material), the reagent causes a chemical reaction with the explosive material and a product of the reaction is generated (e.g., H₂O₂). The generated product becomes in contact with the electrodes 1925, 1926, 1927 and an electrical signal (e.g., current) flows through the electrodes in response to an applied working potential. The electrical signal is detected by the reader 1930 when the sample holding unit 1912 interfaces with the reader 1930. The interaction between the sample holding unit 1912 and the reader 1930 can be through the interactions of the electrodes 1925, 1926, 1927 with conductive contacts 1932, 1934 and 1934 of the reader 1930.

Addition features can be incorporated with the reader. For example, the reader 1930 can incorporate a processor 1933 for processing the detected electrical signal. In addition, the reader 1930 can include an output unit 1937 to provide a visual indication of the detection. For example, a positive detection of an explosive material can be indicated by a specific color light (e.g., red for positive detection and green for negative detection). Alternatively, a sound indicator such as an alarm can be implemented to indicate a positive detection of an explosive material.

In some implementations, the reader 130 (along with the contacts 1932, 1934 and 1936), sample holding unit 1912 (along with the reagent holding unit 1914 and the electrodes 1925, 1926, 1927), and the sample gathering unit 1910 can be designed as an integrated unit.

The microelectrode sensor 1900 can be implemented using standard microfabrication methods. For example, an insulator layer, such as SiO₂ or silica, can be grown on the silicon wafer by thermal oxidation. Other insulator layers such as Si₃N₄ can be implemented to electrically isolate different structures or act as an etch mask in bulk micromachining. The electrodes 1925, 1926 and 1927 can be formed by sputtering a conductive layer, such as a gold/titanium (Au/Ti) film with a predetermined thickness.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present invention includes any other applications in which embodiment of the above structures and fabrication methods are used. The scope of the embodiments of the present invention should be determined with reference to claims associated with these embodiments, along with the full scope of equivalents to which such claims are entitled.

Embodiments of the subject matter and the functional operations of the reader 130, display, 410, network 430, processing/storage unit 420 described in this specification can be implemented in digital electronic circuitry, or in computer software, firmware, or hardware, including the structures disclosed in this specification and their structural equivalents, or in combinations of one or more of them. Embodiments of the subject matter described in this specification with respect to the reader 130, display 410, network 430, processing/storage unit 420 can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Operations among the processing/storage unit 420, the display 410, the reader, and the network 430 can be performed by one or more programmable processors executing one or more computer programs to perform functions by operating on input data and generating output. In addition, special purpose logic circuitry, e.g., an FPGA (field programmable gate array) or an ASIC (application specific integrated circuit) can be used.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

The processing/storage unit 420 as described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The computing system can be interconnected to the display 410 and the reader 130 by the network 430 that includes any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

What is claimed is:

1. A system for detecting a target material, the system comprising:
a sample gathering unit configured to obtain a portion of the target material to be tested;
a sample holding unit having a first end configured to attach to the sample gathering unit and form a housing that retains at least the obtained portion of the target material; and
a reagent holding unit attached to a second end of the sample holding unit, wherein the reagent holding unit is configured to introduce the reagent into the formed housing to mix with the obtained target material and start a chemical reaction.

2. The system of claim 1, further comprising:
an electrochemical sensor unit configured to interface with contents of the formed housing; and
a reader configured to interface with the conductive sensor unit to detect an electrical signal associated with the contents of the formed housing.

3. The system of claim 2, wherein the electrochemical sensor unit comprises:
a working electrode; and
at least one of a reference electrode and a counter electrode.

4. The system of claim 3, wherein the reader is configured to interface with the electrochemical sensor unit to detect the electrical signal associated with the contents of the formed housing comprising
applying a potential through the interfaced electrochemical sensor;
in response to the applied potential, measuring at least one of
an electrical potential between the working electrode and one of the reference electrode and the counter electrde, and
an electrical current between the working electrode and one of the reference electrode and counter electrode, and
processing the measured at least one of the electrical potential and electrical current to generate an output signal that indicates a presence or absence of a reaction between an explosive material and the reagent.

5. The system of claim 1, wherein the target material comprises an explosive material.

6. The system of claim 1, wherein
the target material comprises one of urea nitrate and a peroxide-based explosive material; and
the reagent comprises a mixture of a solvent and an acid.

7. The system of claim 6, wherein
the target material comprises urea nitrate (UN); and
the reagent comprises p-nitrotoluene (NT) based mixture.

8. The system of claim 6, wherein
the target material comprises one of triacetone triperoxide (TATP) and hexamethylene triperoxide diamine (HMTD); and
the reagent comprises hydrochloric acid (HCl) based mixture.

9. The system of claim 4 further comprising a display unit for displaying the determined electrical potential and electrical current.

10. The system of claim 4 further comprising a computing system for processing the determined electrical potential and electrical current.

11. A method for detecting a material, the method comprising:
obtaining a sample of a target material to be tested;
sealing the obtained sample of the target material in a detection unit;
introducing a reagent into the detection unit to mix with the target material, wherein the reagent is configured to start a chemical reaction and generate a product when mixed with an explosive material;
measuring an electrochemical signal associated with the mixture of reagent and the target material; and
processing the measured electrochemical signal to generate an output that indicates a presence or absence of a chemical reaction between the target material land the reagent.

12. The method of claim 11, wherein processing the measured electrochemical signal comprises:
obtaining a signal profile associated with the mixture of the reagent and the target material; and
comparing the obtained signal profile against a signal profile associated with a reaction between the reagent and an explosive material.

13. The method of claim 12, wherein comparing the obtained signal profile with the signal profile associated with a reaction between the reagent and an explosive material comprises:
identifying a presence of at least one of urea nitrate and a peroxide-based explosive material in the target material.

14. The method of claim 13, wherein
identifying a presence of at least one of urea nitrate and a peroxide-based explosive material in the target material comprises:
identifying a presence of urea nitrate (UN) in the target material; and
identifying a presence of a reaction product comprising 2,4-dinitrotoluene (2,4-DNT).

15. The method of claim 13, wherein
identifying a presence of at least one of urea nitrate and a peroxide-based explosive material in the target material comprises:
identifying a presence of one of triacetone triperoxide (TATP) and hexamethylene triperoxide diamine (HMTD) in the target material; and
identifying a presence of a reaction product comprising hydrogen peroxide (H₂O₂).

16. The method of claim 12 further comprising displaying the obtained signal profile to a user.

17. The method of claim 11, wherein measuring an electrochemical signal comprises obtaining at least one of an electrical potential and an electrical current.

18. The method of claim 17 further comprising processing the obtained signal profile to determine a relationship between a concentration of an explosive material and a magnitude of the signal profile.

19. The method of claim 11, wherein introducing the reagent into the detection unit comprises automatically introducing the reagent into the detection unit when the obtained sample of the target material is sealed in the detection unit.

20. A system for testing a target material, the system comprising:
a sample gathering unit configured to obtain a portion of the target material to be tested;
a sample holding unit having a first end configured to attach to the sample gathering unit and form a housing that retains at least the obtained portion of the target material; and
a reagent holding unit attached to a second end of the sample holding unit, wherein the reagent holding unit is configured to introduce the reagent into the formed housing to mix with the obtained target material and start a chemical reaction.
an electrochemical sensor unit configured to interface with contents of the formed housing;
a reader configured to interface with the conductive sensor unit to detect an electrical signal associated with the contents of the formed housing; and
a processor configured to process the detected electrical signal to generate an output signal indicative of a presence of an explosive material in the target material, wherein the processing comprises:
generating a voltammetric signal profile that includes a relationship between currents measured and potentials applied;
comparing the generated signal profile against a known signal profile of an explosive material.

21. The detection system of claim 20, further comprising a light source configured to irradiate the target material.

22. A microelectrode sensing device, comprising:
a substrate;
an array of microelectrode sensors formed on the substrate, each microelectrode sensor comprising
one or more conductive layers, that at least partially conducts electricity, formed above the substrate and patterned to comprise at least a working electrode and a reference electrode to measure electrical activities associated with a chemical reaction between a target material and a reagent; and
a reading unit configured to interface the one or more conductive layers, wherein the reading unit detects the measured electrical activities.

23. A method of testing a target material comprising:
obtaining a portion of the target material;
irradiating the obtained portion of the target material;
sealing the irradiated sample of the target material in a detection unit;
in response to sealing the irradiated sample of the target material in a detection unit, automatically introducing a reagent into the detection unit to mix with the target material, wherein the reagent is configured to start a chemical reaction and generate a product when mixed with an explosive material;
measuring an electrochemical signal associated with the mixture of reagent and the target material; and
processing the measured electrochemical signal to generate an output that indicates a presence or absence of a chemical reaction between the target material land the reagent.

24. A compute program product, embodied on a tangible computer readable-medium, operable to cause a data processing apparatus to perform apparatus comprising:
obtain an electrical signal associated with a reaction between a target material and a reagent;
processing the obtained electrical signal to identify a presence of an explosive material in the target material; and
based on the processing, generating an output signal, wherein the generated output signal comprises at least one of
a visual indication of the presence of an explosive material in the target material; and
an audio indication of the presence of an explosive material in the target material.

25. A method comprising
providing a removable sample gathering unit configured to obtain a portion of a target material;
providing a sample holding unit configured to form a housing that retains at least the obtained portion of the target material, wherein the removable sample gathering unit includes a receptor for receiving the removable sample unit;
providing a reagent holding unit configured to
retain a reagent,
interface with the sample holding unit, and
introduces the retained reagent into the formed housing of the sample holding unit when the sample holding unit receives the removable sample gathering unit;
measuring an electrical signal associated with contents of the formed housing of the sample holding unit; and
processing the measured electrical signal to detect a presence of an explosive material in the target material.
